(19) United States
(12) Patent Application Publication
(10) Pub. No.: US 2026/0138690 A1
(43) Pub. Date: May 21, 2026

(54) LOW PIVOT MID-ROLLER OSCILLATING BEAM FOR TRACK SYSTEM

(71) Applicant: CAMSO INC., Magog (CA)

(72) Inventors: Dewaine Kautsch, Magog (CA); Olivier Ravat, Magog (CA)

(73) Assignee: CAMSO INC., Magog, QC (CA)

(21) Appl. No.: 19/121,334

(22) PCT Filed: Nov. 6, 2023
(86) PCT No.: PCT/CA2023/051478

§ 371 Date: Apr. 15, 2025

Related U.S. Application Data
(60) Provisional application No. 63/382,599, filed on Nov. 7, 2022.

(51) Int. Cl. B62D 55/15; B62D 55/10; B62D 55/104; B62D 55/12

(52) U.S. Cl. CPC B62D 55/15; B62D 55/10; B62D 55/104; B62D 55/12

(57) ABSTRACT

There is provided a lateral oscillation system for a track system having a roller support beam couplable to roller wheels and a support assembly rigidly coupled to the frame of the track system. The roller support beam and support assembly are pivotally coupled or in a pivotal relationship such that the roller support beam is provided with roll rotation. The pivotal link or pivotal relationship can be between the roller wheel axles and/or embedded within the roller support beam to provide a lower pivot axis than conventional systems. A low pivot axis reduces the side swing and thus reduces the potential contact between the roller wheels and the guide lugs. The lateral oscillation system can provide a high degree of lateral oscillation without causing friction and/or heat build up when the track system experiences uneven loads.

### PRIOR APPLICATION

The present application claims priority from U.S. provisional patent application No. 63/382,599, filed on Nov. 7, 2022, and entitled “LOW PIVOT MID-ROLLER OSCILLATING BEAM FOR TRACK SYSTEM”, the disclosure of which being hereby incorporated by reference in its entirety.

### TECHNICAL FIELD

This disclosure generally relates to track systems for vehicles (e.g. agricultural vehicles or other industrial vehicles, etc.). More specifically, this disclosure relates to track systems with a low pivot mid-roller oscillating beam.

### BACKGROUND

Certain off-road vehicles, such as agricultural vehicles (e.g. harvesters, combines, tractors, etc.), industrial vehicles, such as construction vehicles (e.g. loaders, bulldozers, excavators, etc.) and forestry vehicles (e.g. feller bunchers, tree chippers, knuckle-boom log loaders, etc.), and military vehicles (e.g. combat engineering vehicles (CEVs), etc.), may be equipped with an elastomeric track system that enhances traction and floatation on soft, wet, and/or irregular ground (e.g. soil, mud, sand, ice, snow, etc.) during operation.

Loads in a vehicle's track systems can vary significantly depending on how and where the vehicle is used, and this can affect performance and durability of their tracks and/or wheels. For example, the track systems need to be responsive to changes in the ground or road profile, such as road crown, in order to reduce the generation of heat and/or unnecessary erosion caused by uneven distribution of the load between the wheels and the track. Furthermore, when the track system is not responsive to the change in ground profile, road crown can be a significant contributor to limiting the speed capability of the vehicle.

Some conventional track systems use a lubricated pivot point to generate an oscillating movement in adjacent wheels. However, these systems have a higher pivot point, which causes a larger side swing, and thus can cause additional friction on the guide lugs. Furthermore, lubricated pivot points require additional maintenance to continue providing oscillating movement. Other track systems can use cylindrical rubber bushings mounted on each axle to individually provide oscillation between adjacent wheels. However, when a pivot point is provided on individual axles, the resulting oscillation on each axle can causes poor ride quality performance during some operating conditions. Accordingly, there is a need for an improved track system.

### SUMMARY

According to one aspect, there is provided a track system for traction of a vehicle, the track system comprising: an undercarriage comprising a track and a track-engaging assembly for driving and guiding the track around the track engaging-assembly, wherein the track engaging-assembly comprises: a plurality of track-contacting wheels comprising a drive wheel for driving the track; a front idler wheel; a rear idler wheel; and a plurality of roller wheels; a frame configured to couple to the vehicle and to the drive wheel, the front idler wheel, and the rear idler wheel; and a lateral oscillation system comprising a roller support beam comprising a plurality of roller wheel axles each configured to be coupled to the plurality of roller wheels; and at least one support assembly rigidly coupled to the frame; wherein the roller support beam and the at least one support assembly are in a pivotal relationship such that the roller support beam is pivotably about a longitudinal pivot axis transversal to an axis of rotation of the plurality of roller wheels by at least +/−1° from a rest position of the roller support beam.

According to another aspect, there is provided a track system for traction of a vehicle, the track system comprising: an undercarriage comprising a track and a track-engaging assembly for driving and guiding the track around the track engaging-assembly, wherein the track engaging-assembly comprises: a plurality of track-contacting wheels comprising a drive wheel for driving the track; a front idler wheel; a rear idler wheel; and a plurality of roller wheels; a frame configured to couple to the vehicle and to the drive wheel, the front idler wheel, and the rear idler wheel; and a lateral oscillation system comprising a roller support beam comprising at least three roller wheel axles configured to be coupled to the plurality of roller wheels and at least two connection assemblies, each disposed longitudinally between adjacent roller wheel axles; and at least two support assembly configured to rigidly couple to the frame and to pivotably couple to the roller support beam at a respective one of the at least two connection assemblies; wherein the lateral oscillation system is configured to provide lateral oscillation to the roller support beam, thereby providing lateral oscillation to the plurality of roller wheels.

In some embodiments, the support assembly comprises a connection flange coupled to a bushing via a guide post and wherein the at least two connection assemblies each comprise a receiving port with an opening extending therethrough and a pin; wherein the roller support beam is pivotally coupled to the at least two support assemblies via the pin extending through the opening in the at least two connection assemblies and through the bushing in the respective one of the at least two support assemblies.

In some embodiments, the bushing comprises a rubber bushing or a steel sleeve bushing.

In some embodiments, the connection flange comprises at least one alignment protrusion configured to be received in an aperture in the frame.

In some embodiments, the connection flange comprises an elevated surface or a depression configured to be received in a frame depression or a frame elevated surface, respectively, in the frame.

In some embodiments, the roller support beam is pivotably about a pivot axis transversal to an axis of rotation of the plurality of roller wheels.

In some embodiments, the pivot axis is between about 50 mm below and about 150 mm above the axis of rotation of the plurality of roller wheels in a heightwise direction.

In some embodiments, the roller support beam is pivotably about the pivot axis by at least +/−1° from a rest position of the roller support beam, by at least +/−2° from a rest position of the roller support beam, or by at least +/−3° from a rest position of the roller support beam.

In some embodiments, the lateral oscillation system further comprises an oscillation stop configured to restrain the lateral oscillation.

In some embodiments, the oscillation stop comprises a first surface and a second surface configured to engage with an underside of the frame or the support assembly.

In some embodiments, the oscillation stop extends upwardly in the heightwise direction from the roller support beam, such that when the support assembly is coupled to the frame, the oscillation stop engages with an underside of the frame during lateral oscillation.

In some embodiments, the first surface and the second surface extend away from each other at a downward angle from a plane extending horizontally from an apex.

In some embodiments, the downward angle is between about 1° and about 10°, between about 1° and about 4°, or about 2°.

In some embodiments, the oscillation stop is positioned on a top side of the connection assembly.

In some embodiments, the first surface is positioned on a first side of the connection assembly and the second surface is positioned on a second side of the connection assembly.

In some embodiments, the first surface and the second surface are provided at an angle extending downwardly and away from either side of the receiving port.

In some embodiments, the angle is between about 1° and about 10°, between about 1° and about 4°, or about 2°.

In some embodiments, the at least three roller wheel axles is a front roller wheel axle, a middle roller wheel axle, and a rear roller wheel axle.

In some embodiments, the at least two connection assemblies are a first connection assembly and a second connection assembly, wherein the first connection assembly is disposed between the front roller wheel axle and the middle roller wheel axle and the second connection assembly is disposed between the middle roller wheel axle and the rear roller wheel axle.

In some embodiments, the at least three roller wheel axles is a first roller wheel axle, a second roller wheel axle, a third roller wheel axle, and a fourth roller wheel axle.

In some embodiments, the at least two connection assemblies is a first connection assembly and a second connection assembly, the first connection assembly being disposed between the first roller wheel axle and the second roller wheel axle and the second connection assembly being disposed between the third roller wheel axle and the fourth roller wheel axle.

In some embodiments, the at least two connection assemblies further comprise a third connection assembly disposed between the second roller wheel axle and the third roller wheel axle.

In some embodiments, the track-engaging assembly is devoid of a suspension system that enables additional damping movement in the vertical direction.

According to another aspect, there is provided a lateral oscillation system for a track system of a vehicle, the lateral oscillation system comprising: a roller support beam having at least three roller wheel axles and at least two connection assemblies, each disposed between adjacent roller wheel axles; and at least two support assemblies configured to pivotably couple to the roller support beam via the at least two connection assemblies and configured to rigidly couple to a frame of the track system.

In some embodiments, the at least three roller wheel axles are configured to be coupled to a plurality of roller wheels of the track system.

In some embodiments, the at least two connection assemblies comprise a receiving port configured to receive a portion of the support assembly, an opening, and a pin receivable through the opening.

In some embodiments, each of the at least two support assemblies comprise:
a connection flange configured to rigidly couple to the frame of the track system; and a bushing configured to receive the pin of a respective one of the at least two connection assemblies to pivotably couple a respective one of the at least two support assemblies to the roller support beam.

In some embodiments, each of the at least two support assemblies further comprise a guide post extending between the connection flange and the bushing.

In some embodiments, the roller support beam is pivotably about the pivot axis by between about 1° and about 10°, between about 2° to about 3°, or about 3° from a rest position of the roller support beam.

In some embodiments, the oscillation stop extends upwardly in a heightwise direction from the roller support beam, such that when the support assembly is coupled to the frame, the oscillation stop engages with an underside of the frame during lateral oscillation.

In some embodiments, the at least two connection assemblies is a first connection assembly and a second connection assembly, wherein the first connection assembly is disposed between the front roller wheel axle and the middle roller wheel axle and the second connection assembly is disposed between the middle roller wheel axle and the rear roller wheel axle.

In some embodiments, the at least three roller wheel axles is a first roller wheel axle, a second roller wheel axle, a third roller wheel axle, and a fourth roller wheel axle.

In some embodiments, the at least two connection assemblies are a first connection assembly and a second connection assembly, the first connection assembly being disposed between the first roller wheel axle and the second roller wheel axle and the second connection assembly being disposed between the third roller wheel axle and the fourth roller wheel axle.

According to another aspect, there is provided a track system for a vehicle, the track system comprising: an elastomeric track; and a track-engaging assembly configured to drive and guide the track around the track-engaging assembly, wherein the track-engaging assembly comprises: a plurality of first track-contacting wheels coupled to a frame; a plurality of second track-contacting wheels coupled to a support beam; and a support assembly pivotably coupled to the support beam and rigidly coupled to the frame, wherein the track-engaging assembly is configured such that the plurality of second track-contacting wheels are pivotable about a pivot axis transversal to an axis of rotation of the plurality of second track-contacting wheels; and wherein the track-engaging assembly is devoid of a suspension system that enables additional damping movement in the vertical direction.

In some embodiments, the support beam comprises at least one connection assembly configured to receive and pivotably couple to the support assembly.

In some embodiments, the support assembly comprises a bushing configured to pivotally couple the support assembly to the support beam via a pin extending through an opening in the at least one connection assembly of the support beam.

In some embodiments, the pivot axis is between about 50 mm below and about 150 mm above the axis of rotation of the plurality of roller wheels in the heightwise direction.

In some embodiments, the support beam is pivotable about the pivot axis by between about 1° and about 10°from a rest position of the support beam, between about 2° and about 5° from a rest position of the support beam, or by about 3° from a rest position of the support beam.

In some embodiments, the support beam further comprises an oscillation stop configured to restrain the lateral oscillation that comprises a first surface and a second surface configured to engage with an underside of the frame or the support assembly.

In some embodiments, the oscillation stop extends upwardly in the heightwise direction from the support beam, such that when the support assembly is coupled to the frame, the oscillation stop engages with an underside of the frame during lateral oscillation.

In some embodiments, the first surface and the second surface extend away from each other at a downward angle from a plane extending horizontally from an apex.

In some embodiments, the downward angle is between about 1° and about 10°, between about 1° and about 4°, or about 2°.

In some embodiments, the oscillation stop is positioned on a top side of the at least one connection assembly.

In some embodiments, the first surface is positioned on a first side of the at least one connection assembly and the second surface is positioned on a second side of the at least one connection assembly.

In some embodiments, the plurality of second track-contacting wheels are coupled to the support beam via at least three axles.

In some embodiments, the at least three axles are a front axle, a middle axle, and a rear axle.

In some embodiments, the at least one connection assembly is a first connection assembly and a second connection assembly, wherein the first connection assembly is disposed between the front axle and the middle axle and the second connection assembly is disposed between the middle axle and the rear axle.

In some embodiments, the at least three axles is a first axle, a second axle, a third In some embodiments, the at least one connection assembly is a first connection assembly and a second connection assembly, the first connection assembly being disposed between the first axle and the second axle and the second connection assembly being disposed between the third axle and the fourth axle.

In some embodiments, the at least one connection assembly further comprises a third connection assembly disposed between the second axle and the third axle.

According to another aspect, there is provided a lateral oscillation system for a track system of a vehicle, the lateral oscillation system comprising: a roller support beam having at least three axles configured to be coupled to roller wheels of the track system; and at least two support assemblies configured to pivotably couple to the roller support beam and configured to rigidly couple to a frame of the track system; wherein the at least two support assemblies are the only part of the lateral oscillation system that dampens vertical impacts between the at least three axles and the frame.

In some embodiments, the roller support beam comprises at least two connection assemblies each disposed between adjacent ones of the at least three axles, wherein the at least two support assemblies are pivotably coupled to the roller support beam via the at least two connection assemblies.

In some embodiments, the pivotal coupling between the roller support beam and the support assembly is embedded within the roller support beam.

In some embodiments, the pivotal coupling between the roller support beam and the support assembly is via a bushing disposed around a body of the roller support beam.

In some embodiments, the roller support beam is pivotable about a pivot axis transversal to an axis of rotation of the at least three axles and/or is pivotable about a pivot axis substantially parallel to a longitudinal axis of the track system.

According to another aspect, there is provided a lateral oscillation system for a track system for a vehicle, the lateral oscillation system comprising a roller support beam coupled to at least two bushings embedded in the roller support beam, the at least two bushings being pivotally coupled to the roller support beam and rigidly coupled to a frame of the track system.

In some embodiments, the at least two pivotal links are disposed between adjacent roller wheel axles of the roller support beam.

In some embodiments, the at least two pivotal links are each enclosed in a support assembly, wherein the support assembly is configured to be rigidly coupled to the frame of the track system.

In some embodiments, the at least two pivotal links are the only part of the lateral oscillation system that dampens vertical impacts between the roller support beam and the frame.

According to another aspect, there is provided a lateral oscillation system for a track system of a vehicle, the lateral oscillation system comprising a roller support beam comprising at least three roller wheel axles configured to coupled to a plurality of roller wheels of the track system; and at least two support assemblies configured to be rigidly coupled to a frame of the track system and to be pivotably coupled to the roller support beam; wherein the pivotably coupling between the roller support beam and the at least two support assemblies is disposed between adjacent ones of the at least three roller wheel axles and wherein the pivotably coupling provides the plurality of roller wheels with about 1° to about 10° of lateral movement in a roll direction.

In some embodiments, the lateral movement in the plurality of roller wheels is around a pivot axis transversal to an axis of rotation of the plurality of roller wheels.

In some embodiments, the pivot axis is between about 50 mm below and about 150 mm above the axis of rotation of the plurality of roller wheels in a heightwise direction.

### BRIEF DESCRIPTION OF THE DRAWINGS

A detailed description of embodiments of the present disclosure is provided below, by way of example only, with reference to the accompanying drawings, in which:

FIG. 1 shows an example of an agricultural vehicle comprising a track system in accordance with an embodiment;

FIG. 2 shows a perspective side view of a track system according to one embodiment;

FIG. 3 shows an exploded view of the track system shown in FIG. 2, including a lateral oscillation system according to one embodiment;

FIG. 4 shows an enlarged view of the track system shown in FIG. 2, including the connection between a frame of the track system and the lateral oscillation system;

FIG. 5 shows a perspective side view of a lateral oscillation system according to one embodiment;

FIG. 6 shows an exploded view of the lateral oscillation system shown in FIG. 5;

FIG. 7 shows a perspective cross-sectional view of the lateral oscillation system shown in FIG. 5;

FIG. 8 shows a front cross-sectional view of the lateral oscillation system shown in FIG. 5; FIG. 9 shows an exploded front cross-sectional view of the lateral oscillation system shown in FIG. 5;

FIG. 10 shows an enlarged perspective cross-sectional view of the lateral oscillation system shown in FIG. 5;

FIG. 11 shows an exploded perspective view of a support assembly of the lateral oscillation system shown in FIG. 5 is shown;

FIG. 12 shows a front cross-sectional view of an oscillation stop on a roller support beam of the lateral oscillation system shown in FIG. 5;

FIG. 13 shows a side perspective view of a lateral oscillation system according to another embodiment;

FIG. 14 shows an enlarged view of the lateral oscillation system shown in FIG. 13;

FIG. 15 shows an exploded perspective view of a support assembly of the lateral oscillation system shown in FIG. 13;

FIG. 16 shows a front cross-sectional view of an oscillation stop on a roller support beam of the lateral oscillation system shown in FIG. 13;

FIG. 17 shows a front cross-sectional view of a track system according to another embodiment;

FIGS. 18A to 18C show an illustration demonstrating the side swing action of the mid-rollers based on a high position of the pivot axis (FIG. 18A) versus a low position of the pivot axis (FIGS. 18B and 18C);

FIG. 19 shows a perspective side view of the lateral oscillation system shown in FIG. 13 in another configuration with a tie bar;

FIG. 20 shows a perspective side view of a portion of the lateral oscillation system shown in FIG. 19;

FIG. 21 shows a perspective side view of a lateral oscillation system according to another embodiment;

FIG. 22 shows the lateral oscillation system shown in FIG. 21 coupled to a frame of a track system;

FIG. 23 shows a perspective top view of a roller support beam of the lateral oscillation system shown in FIG. 21;

FIG. 24 shows a perspective bottom view of the roller support beam shown in FIG. 23;

FIG. 25 shows a perspective side view of a guide post assembly of the lateral oscillation system shown in FIG. 21;

FIG. 26 shows a perspective side view of the roller support beam shown in FIG. 23 coupled to the guide post assembly shown in FIG. 25;

FIG. 27 shows a cross-sectional view of the lateral oscillation system shown in FIG. 21 taken at a line extending transversely to the longitudinal direction of the lateral oscillation system through the guide post assembly;

FIG. 28 shows a cross-sectional view of the lateral oscillation system shown in FIG. 21 taken at a line extending transversely to the longitudinal direction of the lateral oscillation system through the guide post assembly, where the roller support beam is shown at a roll rotation (or lateral oscillation) angle in a first direction of about 2 degrees;

FIG. 29 shows a cross-sectional view of the lateral oscillation system shown in FIG. 21 taken at a line extending transversely to the longitudinal direction of the lateral oscillation system through the guide post assembly, where the roller support beam is shown at a roll rotation (or lateral oscillation) angle in a second direction of about 2 degrees;

FIG. 30 shows a perspective side view of a connection flange of the lateral oscillation system shown in FIG. 21;

FIG. 31 shows an exploded side view of the connection flange shown in FIG. 30;

FIG. 32 shows a cross-sectional side view of the lateral oscillation system coupled to the frame of the track system shown in FIG. 22 taken at a line extending in the longitudinal direction of the lateral oscillation system through the guide post assemblies;

FIG. 33 shows a perspective cross-sectional view of the lateral oscillation system shown in

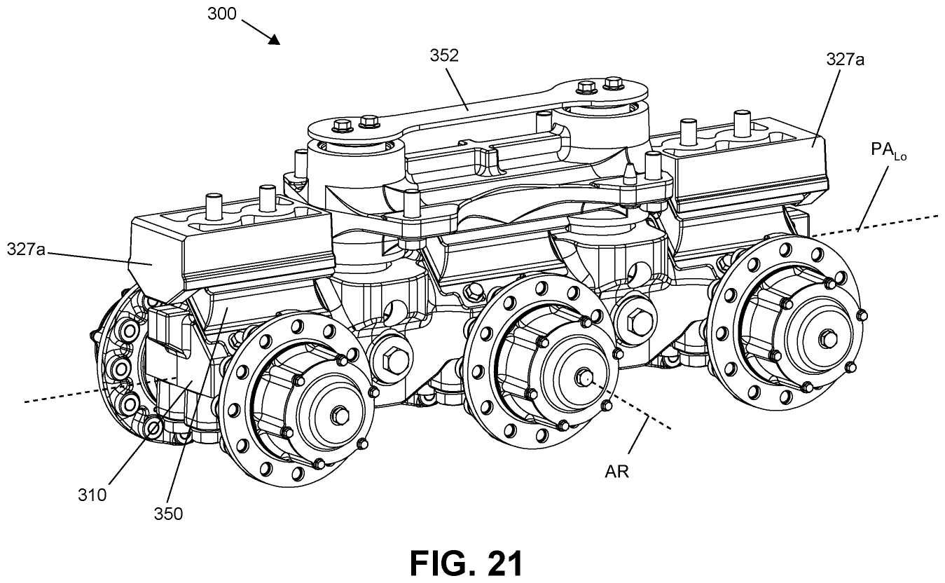

FIG. 21 taken at a line extending transversely to the longitudinal direction of the lateral oscillation system through a roller wheel axle;

FIG. 34 shows a perspective side view of a lateral oscillation system according to another embodiment with portions of a frame shown in their relative positions when the lateral oscillation system is coupled to the frame of the track system;

FIG. 35 shows a perspective side view of the lateral oscillation system shown in FIG. 34 coupled to the frame of a track system;

FIG. 36 shows a perspective side view of a roller support beam of the lateral oscillation system shown in FIG. 34;

FIG. 37 shows an exploded perspective view of the lateral oscillation system shown in FIG. 34, showing the roller support beam of FIG. 36, a support assembly, and suspension pads;

FIG. 38 shows a perspective side view of the lateral oscillation system shown in FIG. 37;

FIG. 39 shows a cross-sectional side view of the lateral oscillation system coupled to the frame of the track system shown in FIG. 35 taken at a line extending in the longitudinal direction of the lateral oscillation system;

FIG. 40 shows a perspective side view of the lateral oscillation system shown in FIG. 34;

FIG. 41A shows an enlarged perspective view of the lateral oscillation system shown in

FIG. 34 taken at a longitudinal end of the roller support beam;

FIG. 41B shows an enlarged perspective view of an axle clamp shown in FIG. 41A;

FIG. 42 shows a bottom or underside view of the lateral oscillation system shown in FIG. 34;

FIG. 43 shows an enlarged bottom or underside view of the lateral oscillation system shown in FIG. 42 taken at a longitudinal end of the roller support beam;

FIG. 44 shows a cross-sectional view of the lateral oscillation system shown in FIG. 34 taken at a line extending transversely to the longitudinal direction of the lateral oscillation system through a roller wheel axle;

FIG. 45 shows an enlarged perspective view of the lateral oscillation system shown in FIG. 34 taken at a longitudinal end of the roller support beam;

FIG. 46 shows a cross-sectional view of the lateral oscillation system shown in FIG. 34 taken at a line extending transversely to the longitudinal direction of the lateral oscillation system through a roller wheel axle, where the roller support beam is shown at a roll rotation (or lateral oscillation) angle in a first direction of about 2 degrees;

FIG. 47 shows a cross-sectional view of the lateral oscillation system shown in FIG. 34 taken at a line extending transversely to the longitudinal direction of the lateral oscillation system through a roller wheel axle, where the roller support beam is shown at a roll rotation (or lateral oscillation) angle in a second direction of about 2 degrees;

FIG. 48 is a perspective side view of a wear plate of the portion of the frame shown relative to the lateral oscillation system shown in FIG. 34

FIG. 49 shows a front view of an agriculture vehicle travelling on a crowned road;

FIG. 50 shows an example of an agricultural vehicle comprising two track systems rather than four; and

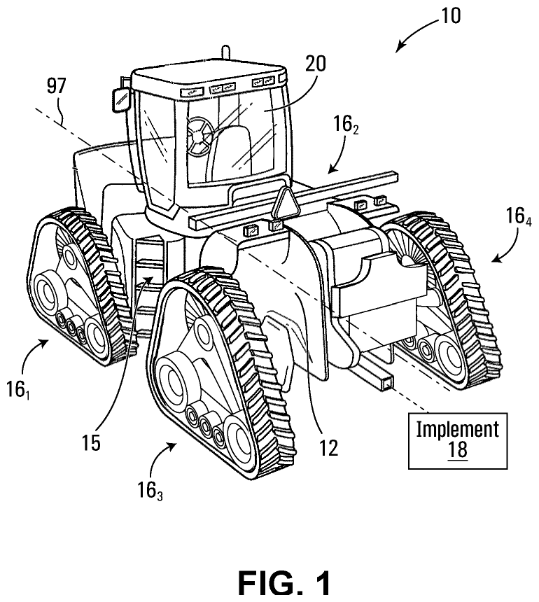

FIG. 51 shows an example of a trailed vehicle configured to be attached to the agricultural vehicle of FIG. 1 or 50.

It is to be expressly understood that the description and drawings are only for the purpose of illustrating certain embodiments of the present disclosure and are an aid for understanding. They are not intended to define the limits of the present disclosure.

### DETAILED DESCRIPTION

As used herein, “substantially”, “approximately”, and “about” means an acceptable variation according to conventional standards, otherwise at most a 5% to 10% variation from an indicated effect or value.

There is provided a track system for a vehicle, such as a heavy-duty work vehicle for performing agricultural, construction or other industrial work, or military work. The track system includes an undercarriage with a track and track-engaging assembly for driving and guiding the track around the track-engaging assembly. The track-engaging assembly includes a drive wheel and front and rear idler wheels coupled to a frame and a plurality of roller wheels (also referred to as mid-rollers) coupled to a lateral oscillation system.

In some embodiments, the lateral oscillation system includes a support assembly that is rigidly coupled to the frame of the track system, and a roller support beam pivotally coupled to or in a pivotal relationship with the support assembly. The roller support beam includes a plurality of axles that are configured to couple to the roller wheels, thus provide lateral oscillation to the roller wheels. The lateral oscillation system is configured to provide about +/−1 to about +/−10 degrees of lateral oscillation to facilitate movement of the roller wheels in the rolling direction of the track system.

In some embodiments, by placing the pivotal link between the support assembly (and thus the frame) and the roller support beam (and thus the roller wheels) between the roller wheel axles and within the roller support beam, the pivot point of the roller support beam can be much lower than conventional systems. By providing a lower pivot point (or pivotal link) between the roller wheels and the frame of the track system, the potential contact between the roller wheels and the drive or guide lugs on the inner side of the track is reduced, thus allowing a high degree of lateral oscillation without causing friction and/or heat build up when the track system experiences uneven loads, such as when on an uneven surface. Moreover, providing a pivotal link, such as a bushing/pin connection, or a pivotal relationship, embedded in or adjacent to the roller support beam can eliminate the requirement for an additional suspension system, as the pivotal link can provide some vertical damping. Accordingly, the track-engaging assembly can be devoid of a suspension system that enables additional damping movement in the vertical direction, thus providing a simpler system with a lower pivot point.

In some embodiments, the above-described track system can be used to convert or retro-fit any wheel vehicle, for example wheeled vehicles with an inboard final drive or with an outboard final drive, to a tracked system. In other embodiments, the track system can be manufactured and installed on a vehicle in the first instance. For example, the vehicle can be an agriculture vehicle, (e.g. harvesters, combines, tractors, etc.), industrial vehicles, such as construction vehicles (e.g. loaders, bulldozers, excavators, telehandlers, etc.) for performing construction work or forestry vehicles (e.g. feller bunchers, tree chippers, knuckle-boom log loaders, etc.) for performing forestry work, military vehicles (e.g. combat engineering vehicles (CEVs), etc.) for performing military work, an all-terrain vehicle (ATV) (e.g. a snowmobile, a four-wheeler, etc.), or any other vehicle operable off paved roads. Although operable off paved roads, the vehicle may also be operated on paved roads in some cases.

Referring now to FIG. 1, an example of an embodiment of a vehicle 10 comprising track systems 16₁-16₄ is shown. In this embodiment, the vehicle 10 is a heavy-duty work vehicle for performing agricultural, construction or other industrial work, or military work. More particularly, in this embodiment, the vehicle 10 is an agricultural vehicle for performing agricultural work. Specifically, in this example, the vehicle 10 is a tractor. In other examples, the vehicle 10 may be a combine harvester, another type of harvester, a planter, or any other type of vehicle. The vehicle 10 comprises a frame 12, a powertrain 15, a steering system 17, and the track systems 16₁-16₄ (which can also be referred to as “undercarriages”) and has a longitudinal axis 97.

The vehicle 10 can travel in an agricultural field to perform agricultural work using a work implement 18. The vehicle 10 can also be “roading”, i.e., travelling on a road (i.e., a paved road having a hard surface of asphalt, concrete, gravel, or other pavement), such as between agricultural fields. As further discussed later, in this embodiment, the track systems 16₁-16₄ of the vehicle 10 are designed to better perform when the vehicle 10 is roading or travelling on uneven surfaces, such as road crown.

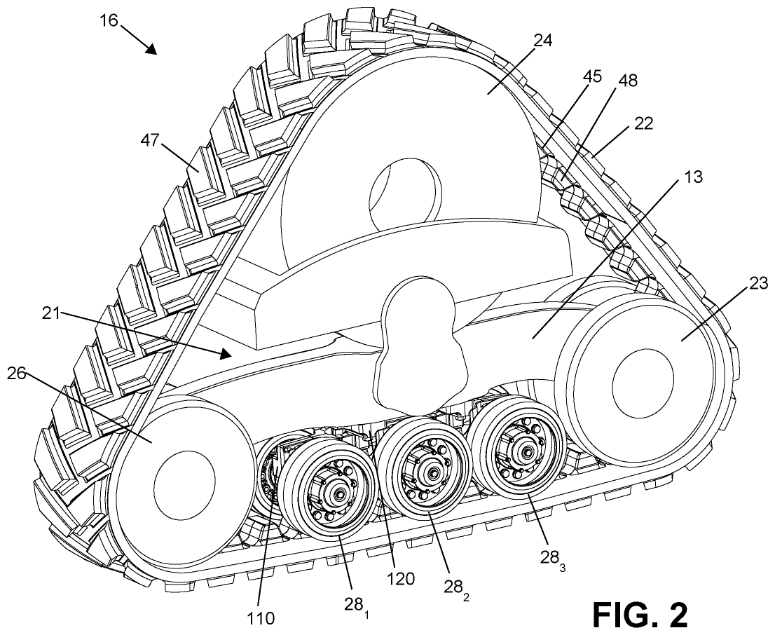

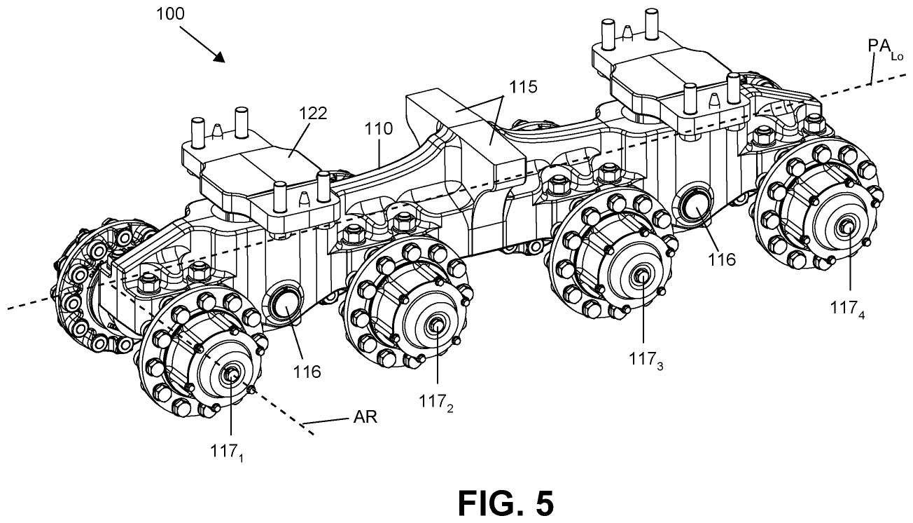

The track systems 16₁-16₄ engage the ground to propel the agricultural vehicle 10. As shown in FIG. 2, each track system 16 comprises a track 22 disposed around a track-engaging assembly 21 that is configured to drive the track 22. In the exemplary embodiment, the track-engaging assembly 21 comprises a plurality of track-contacting wheels which, in this example, includes a drive wheel 24 and a plurality of idler wheels that includes two front (i.e., leading) idler wheels 23, two rear (i.e., trailing) idler wheels 26 and 3 roller wheel axles coupled to 6 roller wheels 28₁-28₃. However, other configurations of track-contacting wheels are possible, such as 2, 4 (as shown in FIG. 5), or 5 roller wheel axles coupled to 4, 8, or 10 roller wheels disposed between the front idler wheels 23 and the rear idler wheels 26.

The track 22 engages the ground to provide traction to the agricultural vehicle 10. A length of the track 22 allows the track 22 to be mounted around the track-engaging assembly 21. In view of its closed configuration without ends that allows it to be disposed and moved around the track-engaging assembly 21, the track 22 can be referred to as an “endless” track. The track 22 comprises an inner side 45 and a ground-engaging outer side 47. The inner side 45 faces the front idler wheels 23, the drive wheel 24, the rear idler wheels 26, and the roller wheels 28₁-28₃, while the ground-engaging outer side 47 engages the ground.

The inner side 45 of the endless track 22 comprises a plurality of wheel-contacting projections 48 that project from the inner side 45 of the track 22 and are positioned to contact at least some of the track-contacting wheels to do at least one of driving (i.e., imparting motion to) the track 22 and guiding the track 22. The wheel-contacting projections 48 can also be referred to as “wheel-contacting lugs”. Furthermore, since each of them is used to do at least one of driving the track 22 and guiding the track 22, the wheel or track-contacting lugs 48 can be referred to as “drive/guide projections” or “drive/guide lugs”. In some implementations, a drive/guide lug 48 may interact with the front and rear idler wheels 23, 26, and/or the adjacent roller wheels 28₁-28₃ to guide the track 22 to maintain proper track alignment and prevent de-tracking without being used to drive the track 22.

In an exemplary embodiment, the drive/guide lugs 48 are arranged in a single row disposed longitudinally within the middle of the inner side 45 of the track 22. The drive/guide lugs 48 may be arranged in other manners in other examples of implementation (e.g., in a plurality of rows that are spaced apart along the widthwise direction of the track 22). In this exemplary embodiment, the drive/guide lugs 48 are configured to pass between respective pairs of the front and rear idler wheels, and/or the roller wheels 28 when they are aligned with one another, such that the lateral surfaces of each drive/guide lug 48 face respecting ones of the front and rear idler wheels, and/or the roller wheels 28 when they are aligned with one another.

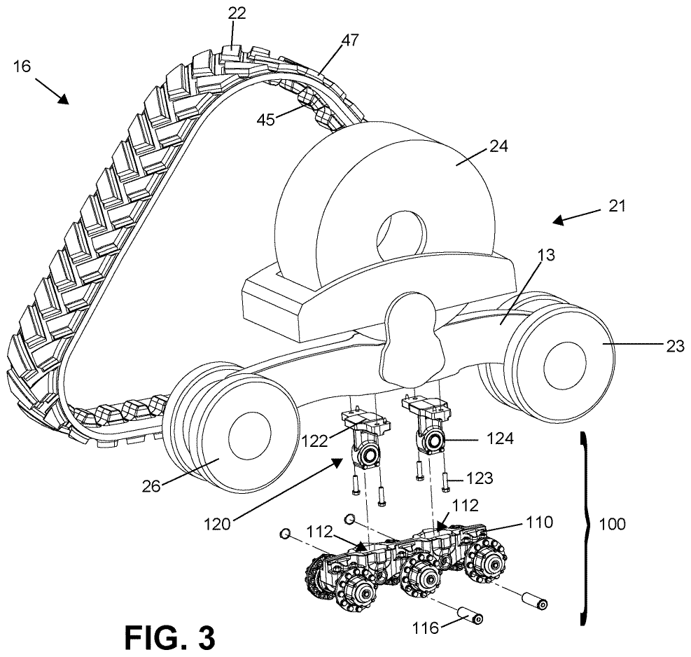

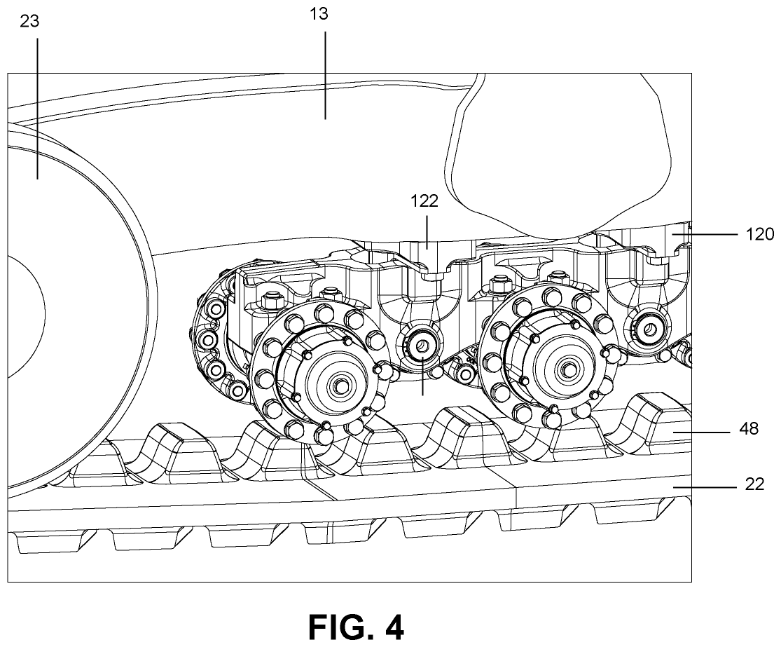

Referring now to FIGS. 3 and 4, the track-engaging assembly 21 also comprises a frame 13 which supports various components of the track system 16, including the front idler wheels 23, the rear idler wheels 26, and the drive wheel 24. The frame 13 is pivotably coupled to a roller support beam 110 via a support assembly 120. As described herein, the pivotal relationship between the frame 13 and the roller support beam 110 is achieved by the support assembly 120 being pivotably coupled to the roller support beam 110 and being rigidly coupled to the frame 13. The roller support beam 110 and the support assembly 120 collectively form a lateral oscillation system 100 that provides the roller wheels 28₁-28₃ with a lateral oscillation or roll capability in relation to the frame 13 via the pivotal motion of the roller support beam 110 relative to the frame 13. In this embodiment, the roller support beam 110 comprises two connection assemblies 112 that each include an opening (as discussed below) configured to receive a portion of the support assembly 120 and a pin 116.

The support assembly 120 comprises a connection flange 122 connected to a bushing 124 via a guide post 126. The connection flange 122 is configured to rigidly connect to the frame 13, for example via fasteners 123, and to pivotally couple to the roller support beam 110 via the bushing 124 (the bushing 124 and the pin 116 being the pivotal link). More specifically, the pin 116 of the connection assembly 112 extends through the bushing 124 to allow the roller support beam 110 to laterally oscillate, thereby imparting a roll motion of the roller support beam 110, and thus of the plurality of roller wheels 28₁-28₃. As can be seen, the lateral oscillation system 100 is devoid of a suspension system that enables additional damping movement in the vertical direction. Indeed, in the exemplary embodiment, the bushing 124 is the only part of the lateral oscillation system that dampens vertical impacts between the roller wheel axles 117₁-117₄, of which the mid-roller wheels 28 are mounted, and the frame 13 that the support assembly 120 is coupled to.

Providing the bushing 124 within the roller support beam 110, when the roller support beam 110 and the support assembly 120 are pivotally coupled, can, in some instances, eliminate the need for a suspension system, thus providing a simpler system that requires less maintenance. Another advantage of not having an additional suspension system on the roller support beam 110 other than the vertical damping provided by the bushing 124 is that the vertical relationship between a bottom tangency of the plurality of roller wheels 28₁-28₃ and the bottom tangency of the front and rear idlers 23, 26 can be precisely controlled. When an additional suspension system is included within the lateral oscillation system 100 (such as in lateral oscillation systems 300, 400), this vertical relationship changes depending on the vertical load of the track system 16 (i.e., as the vertical load increases, the distance between the bottom tangency of the roller wheels 28₁-28₃and the bottom tangency of the front and rear idlers 23, 26 is decreased, and vice versa). In such embodiments, a vertical suspension stop can be utilized to restrain or control the vertical relationship between the bottom tangency of the roller wheels 28₁-28₃and the bottom tangency of the front and rear idlers 23, 26 and/or to avoid over compression of the suspension pads.

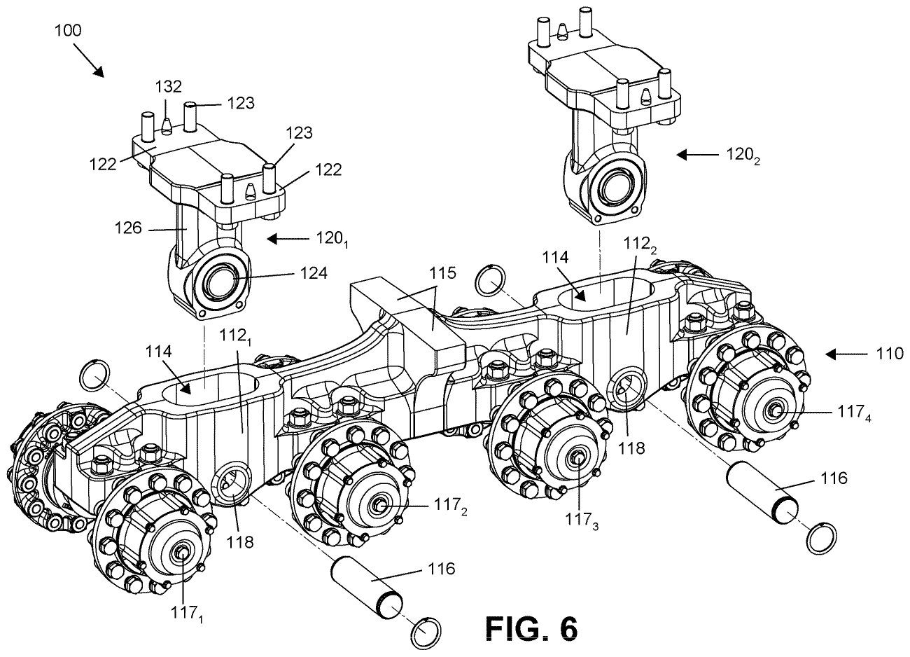

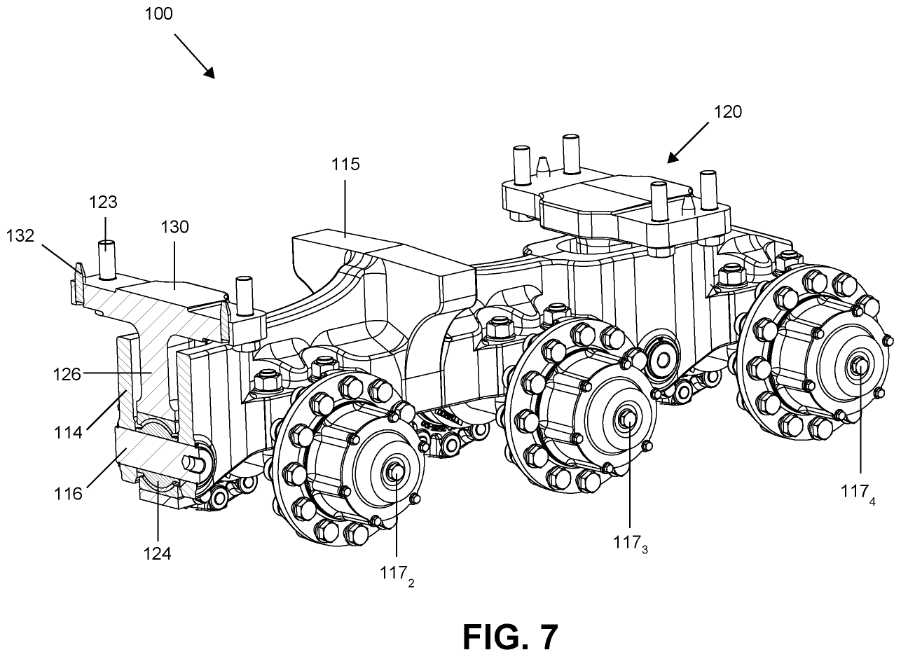

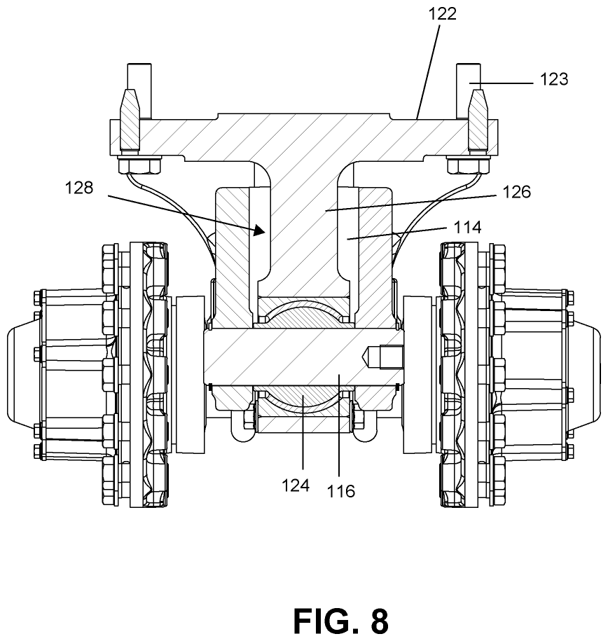

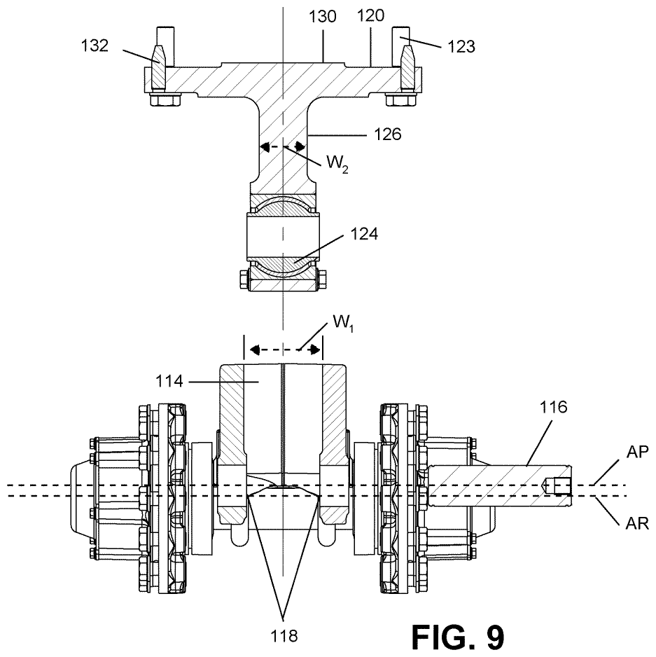

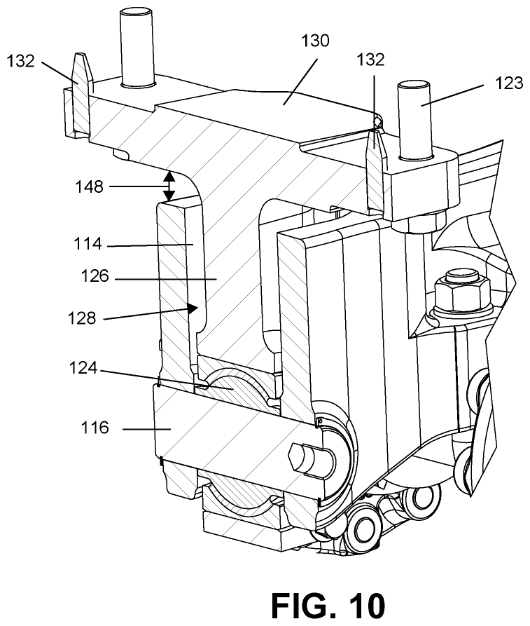

Referring now to FIGS. 5 to 10, the lateral oscillation system 100 is shown. This exemplary embodiment of the lateral oscillation system 100 includes a roller support beam 110 and two support assemblies 120. The support assemblies 120 are rigidly connected to the frame 13 of the track system 16 and pivotally connected to the roller support beam 110, such that the roller support beam 110 is pivotable about a longitudinal pivot axis PA_{LO} that is transverse or perpendicular to the axis of rotation AR of the roller wheels. Accordingly, the roller support beam 100 can pivot in the roll direction relative to the frame 13 of the track system 16, thus imparting a rolling capability to the roller wheels when the track system 16 moves on an uneven ground area. More particularly, in this embodiment, when the lateral oscillation system 100 is coupled to the frame 13 of the track system 16, the longitudinal pivot axis PALo of the roller support beam 110 is parallel or substantially parallel to the longitudinal direction of the track system. Accordingly, the roller support beam 110 is provided with a lateral oscillation or “roll” capability that allows the roller wheels to laterally oscillate or “roll” relative to the frame 13. In some embodiments, the roller support beam 110 can include an oscillation stop 115 configured to limit or control the lateral oscillation provided by the oscillation system 100.

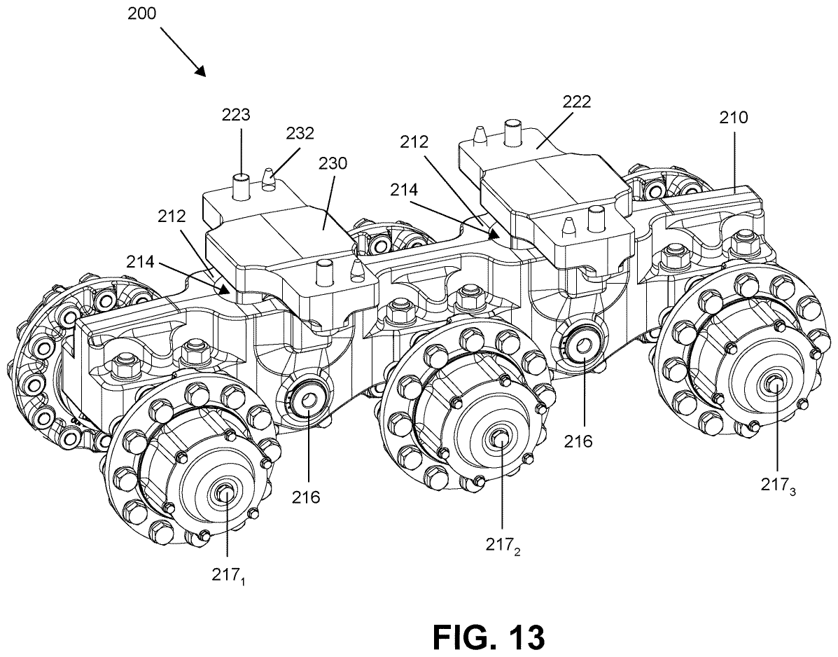

In this exemplary embodiment, the roller support beam 110 includes four roller wheel axles 117₁-117₄ and a first connection assembly 112₁ positioned between a first roller wheel axle 117₁ and a second roller wheel axle 117₂ and a second connection assembly 112₂ positioned between a third roller wheel axle 117₃ and a fourth roller wheel axle 117₄. Accordingly, the connection assemblies 112₁, 112₂ are positioned between adjacent roller wheel axles. It is contemplated that the roller support beam 110 can have a different number of connection assemblies 112, such as a single connection assembly 112 disposed in the middle of the roller support beam 110 (i.e., between the second roller wheel axle 117₂ and the third roller wheel axle 117₃) or three connection assemblies 112 disposed between each of the roller wheel axles 117₁-117₄. In other embodiments, such as the one shown in FIG. 13, the roller support beam 210 can include three roller wheel axles 217₁-217₃ and can include any number of connection assemblies between or adjacent to the roller wheel axles 217₁-217₃.

Referring back to FIGS. 5 to 10, the connection assemblies 112₁ and 112₂ each include a blind hole or receiving port 114 configured to receive a portion of a respective one of the support assembly 120₁, 120₂. The connection assemblies 112₁ and 112₂ further include a pin 116 and an opening 118 extending through the side walls of the receiving port 114. The pin is configured to extend through a first side of the opening 118, be received in a bushing 124 of the support assembly 120, and extend through a second side of the opening 118.

In the exemplary embodiment, each of the support assemblies 120 include at least one connection flange 122 coupled to a bushing 124 via a guide post 126. The connection flange 122 is configured to rigidly couple to the frame 13 of the track system and the bushing 124 is configured to receive the pin 116 of the connection assembly 110 to pivotally couple the support assembly 120 to the roller support beam 110. The connection flange 122 can include apertures configured to receive a fastener 123 to rigidly couple the support assembly 120 to the frame of the track system. While fasteners 123 are used in this embodiment, other methods of rigid coupling are also possible, such as welding. Alternatively, the support assembly 120 can be an integrated piece with the frame 13.

In some embodiments, the connection flange 122 is a planar surface configured to abut against a bottom side of the frame 13 of the track system 16. In the exemplary embodiment, the connection flange 122 includes an elevated surface 130 that can be configured to be received in a groove or depression on an underside of the frame 13 of the track system 16. In some embodiments, the connection flange 122 can include alignment protrusions 132 that are configured to be received in an aperture on the underside of the frame 13 of the track system 16 to align the support assembly 120 to the frame 13, such that the support assembly can be rigidly coupled to the frame 13 of the track system 16. In the exemplary embodiment, the alignment protrusions 132 have tapered ends that facilitate an ease of entry into the apertures in the frame 13. It is contemplated that other coupling mechanisms can be used, including protrusions or elevated surfaces on an underside of the frame 13 of the track system 16 that are configured to be received in apertures or a depression on the connection flange 122.

The bushing 124 on the support assembly 120 provides the pin 116 with a range of motion of the pin 116 in the roll direction (i.e., slight rotation or pivoting around a longitudinal axis of the roller support beam 110). When the track system 16 is on an uneven surface, such as a crowned road, the roller support beam 110, and thus the mid-roller wheels 28₁-28₃, are provided with a range of motion in the roll direction as the pin 116 compresses a bottom side of the bushing 124, which compresses slightly to allow the pin 116 in the opening 114 to adjust the angle of the roller support beam 110 in relation to the frame 13 of the track system 16.

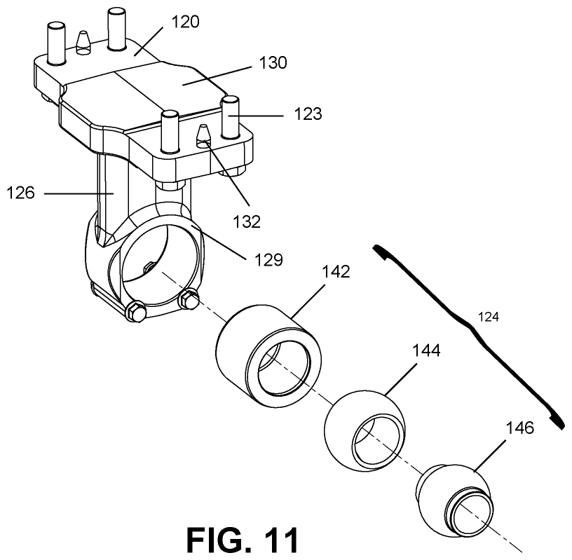

Referring now to FIG. 11, in some embodiments, the bearing 124 can includes an inner sleeve 142, a middle layer 144, and an outer sleeve 146. In the exemplary embodiment, the bushing 124 is a rubber metal bonded bushing (also referred to as a sleeve bushing) with concentric metal inner and outer sleeves 142, 146 and a rubber middle layer 144. The bushing 124 is housed in a housing 129 at an opposite end of the guide post 126 from the connection flange 122.

When the pin 116 is inserted in the bushing 124, there may be a very small clearance for ease of insertion. However, the relative motion in the bushing when the pin 116 is pivoting should be between the inner sleeve 142 and the outer sleeve 146, as the rubber middle layer 144 compresses. The middle layer 144 allows for some relative motion between the inner sleeve 142 and the outer sleeve 146. However, as the angles of motion between the pin 116 and the bushing 124 are small, the relative motion between the inner sleeve 142 and the outer sleeve 146 is small. While a sleeve bushing is contemplated for the exemplary embodiment of a support assembly 120, it is contemplated that the bushing 124 can be any bearing suitable for passive vibration/oscillation applications. For example, steel spherical roller bearings can be used; however, consideration of the lubrication requirements for the bearings should be given when choosing a suitable bearing 124. In the exemplary embodiment, steel sleeve bushings were used as they require little or no lubrication maintenance (i.e., greasing).

As shown, the connection flange 122 is coupled to the bushing 124 via the guide post 126. In some embodiments, the guide post 126 should be of a sufficient length to provide a clearance of the connection flange 120 from the roller support beam 110 that will allow the roller support beam 110 to laterally oscillate without interference from a bottom side of the connection flange 122, which is coupled to the frame 13 of the track system. Accordingly, when the support assembly 120 is pivotally coupled to the roller support beam 110, there is a gap 148 between a topside of the connection assembly 112 near a periphery of the receiving port 114.

The receiving port 114 of the roller beam support 110 is sized and shaped to receive the bushing 124 and the guide post 126. When the pin 116 extends through the opening 118 and the bushing 124, the resilient nature of the bushing 124 provides lateral oscillation movement of the pin 116, thus imparting lateral oscillation movement to the roller support beam 110. Accordingly, the size of the receiving port 114 should have a width W₁ that is wider than a width W₂ of the guide post 126, thereby providing a gap 128 between the outer lateral walls of the guide post 126 and the lateral inner walls of the receiving port 114. The gap 128 provides a clearance for the guide post 126 during lateral oscillation of the roller support beam 110.

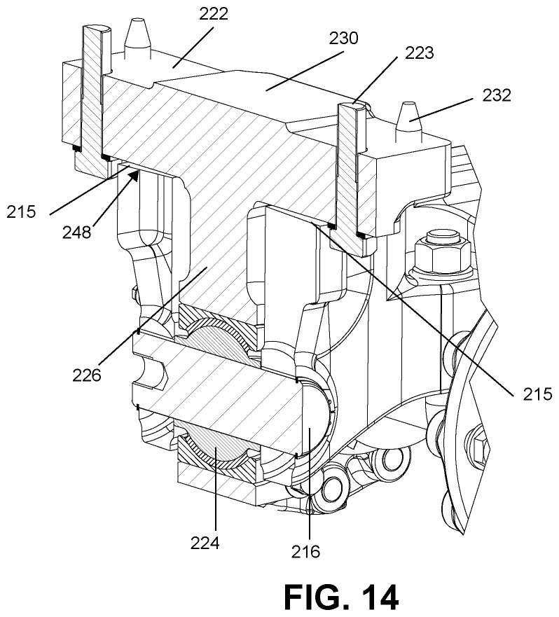

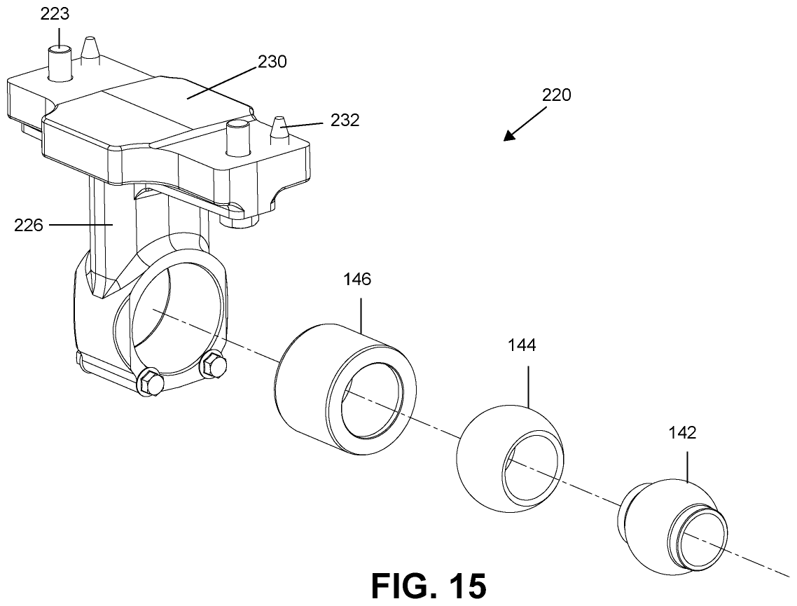

Referring now to FIGS. 13 to 15, a lateral oscillation system 200 according to another embodiment is shown. In this exemplary embodiment, the lateral oscillation system 200 includes a roller support beam 210 that includes three mid-roller axles 217₁-217₃ configured to couple to 6 roller wheels (not shown) and a support assembly 220. As can be seen, there are two connection assemblies 212 in the roller support beam 210, each positioned between adjacent ones of the mid-roller axles 217₁-217₃, or more specifically, a first one positioned between a front mid-roller axle 217₁ and a middle front mid-roller axle 217₂ and a second connection assembly 212 positioned between the middle front mid-roller axle 217₂ and a rear mid-roller axle 217₃. The connection assemblies 212 each comprise a receiving port 214, a pin 216, and an opening (not shown).

The support assembly 220 comprises a connection flange 222 and a bushing 224 coupled together with a guide post 226. The connection flange 222 can include alignment projections 232 and/or fasteners 223, configured to align and rigidly couple, respectively, the connection flange 222 to an underside of the frame 13 of the track system 16. In some embodiments, the connection flange 222 can include an elevated surface 230 that can be configured to be received in a groove or depression on an underside of the frame 13 of the track system 16.

In both lateral oscillation systems 100, 200, an oscillation stop 115, 215 can be used to moderate or restrain the lateral oscillation allowed by the bushing 124, 224. In implementations, such as the lateral oscillation system 100, which does not contain a receiving port 114 between mid-roller axle 117₂ and mid-roller axle 117₃, the oscillation stop 115 can be positioned on a top surface of the roller support beam 110, in the space between the mid-roller axles 117₂, 117₃. Accordingly, when the roller support beam 110 laterally oscillates, the frame 13 of the track system 16 restrains the lateral oscillation of the roller support beam 110 to a predetermined amount. However, when a receiving port is present between each of the mid-roller axles, such as with lateral oscillation system 200 or an embodiment containing four mid-roller axles and receiving ports (not shown), the oscillation stop 215 can be placed on a top surface of the connection assembly 212 around the peripheral top surface of the receiving port 214, such that when the roller support beam 210 laterally oscillates, an engagement between the underside of the connection flange 222 on the support assembly 220 and the top surface of the connection assembly 212 (and thus the roller support beam 210) restrains the lateral oscillation of the roller support beam 210 to a predetermined amount.

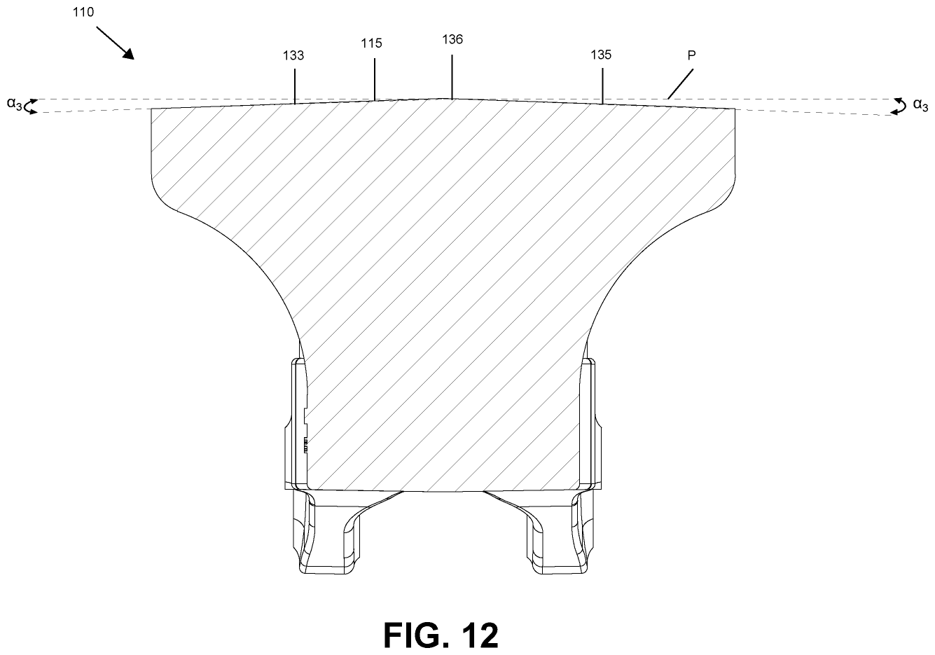

Referring back to FIG. 12, a close-up cross-sectional view of the roller support beam 110 showing the oscillation stop 115 for the lateral oscillation system 100. As can be seen, the oscillation stop 115 includes a first planar surface 133 and a second planar surface 135 that extend away from each other at a slight downward angle from an apex 136 of the oscillation stop 115. The planar surfaces 133, 135 can be provided at an angle α₃ with respect to an imaginary plane P extending horizontally at the apex 136. The angle α₃ can be adjusted according to the desired oscillation or roll capability being imparted on the roller support beam 110. In some embodiments, the angle α₃ is between about 1° and about 10°, and preferably between about 1° and about 4°. In some embodiments, the angle α₃ is about 2°, thus allowing the mid-rollers to laterally oscillate or roll by about 2° on either side of the roller support beam 110. In this exemplary embodiment, the lateral oscillation of the roller support beam 110 is restrained by the frame 13 of the track system 16 contacting the first and second planar surfaces 133, 135. In some embodiments, the contact or mating surface of the oscillation stop 115 on the underside of the frame 13 is a planar surface that is substantially horizontal or parallel to the ground surface, such that the angle α₃ from the horizontal defines the range of allowed oscillation (i.e., if both surfaces 133, 135 have an angle α₃ of 2°, the roller support beam 110 would have an allowed lateral oscillation (roll capability) of 2° on both sides).

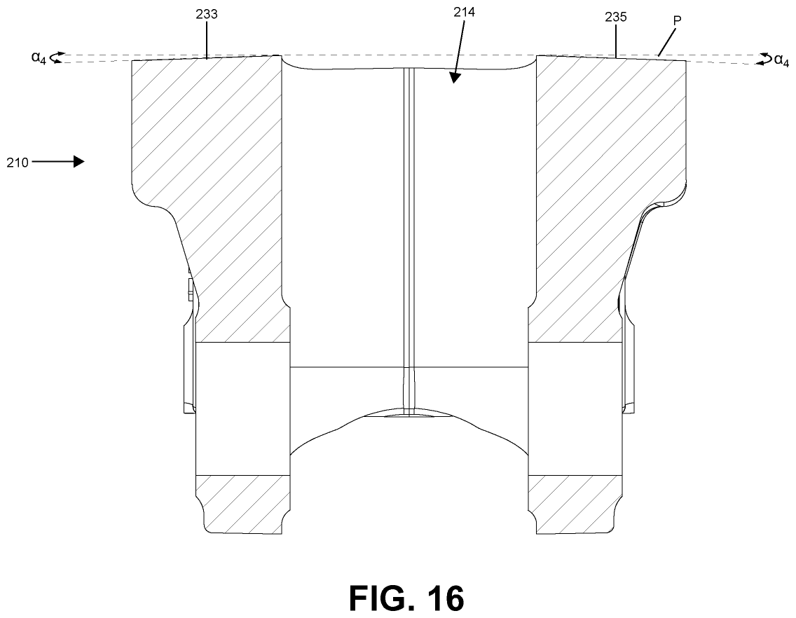

Referring now to FIG. 16, a close-up cross-sectional view of the roller support beam 210 showing the oscillation stop 215 for the lateral oscillation system 200. In this exemplary embodiment, the oscillation stop 215 includes a first planar surface 233 positioned on a first side of the top surface surrounding the receiving port 214 and a second planar surface 235 positioned on a second side of the top surface surrounding the receiving port 214. Accordingly, when the lateral oscillation system 200 is activated, the lateral oscillation is restrained by an underside of the support assembly 220 (in this case, an underside of the connection flange 222) contacting the first or second surface of the oscillation stop 215. The first and second surfaces 233, 235 can be provided at an angle α₄ with respect to an imaginary horizontal plane parallel to the underside of the support assembly 220. The angle α₄ can be adjusted according to the desired oscillation or roll capability being imparted on the roller support beam 210. In some embodiments, the angle α₄ is between about 1° and about 10°, and in some instances, between about 1° and about 4°. In some embodiments, the angle α₄ is about 2°, thus allowing the mid-rollers to laterally oscillate or roll by about 2° on either side of the roller support beam 210. In the exemplary lateral oscillation system 200, the gap 248 between a topside of the connection assembly 212 near a periphery of the receiving port 214 provides the slight clearance needed for the roller support beam 210 to pivot around the support assembly 220. When the roller support beam 210 pivots to one side, the pivotal motion is stopped by the oscillation stop 215, and thus the gap 248 on that side would be negligible and the gap 248 on the opposing side would be wider than when in the neutral or rest position. In some embodiments, the contact or mating surface of the oscillation stop 215 on the underside of the support assembly 220 is a planar surface that is substantially horizontal or parallel to the ground surface, such that the angle α₄ from the horizontal defines the range of allowed oscillation (i.e., if both surfaces 233, 235 have an angle α₄ of 2°, the roller support beam 210 would have an allowed lateral oscillation (roll capability) of 2° on both sides).

As best shown in FIG. 9, the lateral oscillation systems 100, 200 provide a pivot point or longitudinal pivot axis PA_{LO} that transverses and is in line with the axis AP of the pin 116, which, in the embodiments shown in FIGS. 1 to 17, is slightly higher than the axis of rotation AR of the roller wheels. In some embodiments, the longitudinal pivot axis PA_{LO} can be between about 0.1 mm and about 150 mm above the axis of rotation AR of the roller wheels. One advantage to providing a lower pivot point than conventional track systems is to reduce the amount of side swing of the rollers in relation to the track 22. In other embodiments, the longitudinal pivot axis PA_{LO} can be in line with the axis of rotation AR of the roller wheels, or can be up to 50 mm below the axis of rotation AR of the roller wheels.

For example, in the exemplary embodiment, the mid-rollers 28 have a diameter of approximately 330 mm, such that the axis of rotation AR of the mid-rollers 28 is approximately 165 mm from the bottom tangency of the mid-rollers 28. The longitudinal pivot axis PA_{LO} of the roller support beam 110 (traversing the axis AP of the pin 116) is approximately 15 mm above the axis of rotation AR, and thus about 180 mm from the bottom tangency of the mid-rollers 28 (see FIG. 9). As the roll rotation is provided by the coupling between the bushing 124 and the receiving port 114 embedded in the roller support beam 110, the skilled artisan would understand that minor modifications could be made to use the lateral oscillation system 100 with larger mid-rollers 28, which can change the axis of rotation AR of the mid-rollers 28 without moving the longitudinal pivot axis PA_{LO} of the roller support beam 110. In some embodiments, the lateral oscillation system 100 can be used with 426 mm mid-rollers 28, such that the axis of rotation AR of the mid-rollers 28 is approximately 213 mm from the bottom tangency of the mid-rollers 28, whereas the longitudinal pivot axis of the roller support beam 110 remains at 180 mm from the bottom tangency of the mid-rollers 28. In such embodiments, the longitudinal pivot axis PA_{LO} is about 33 mm below the axis of rotation of the roller wheels.

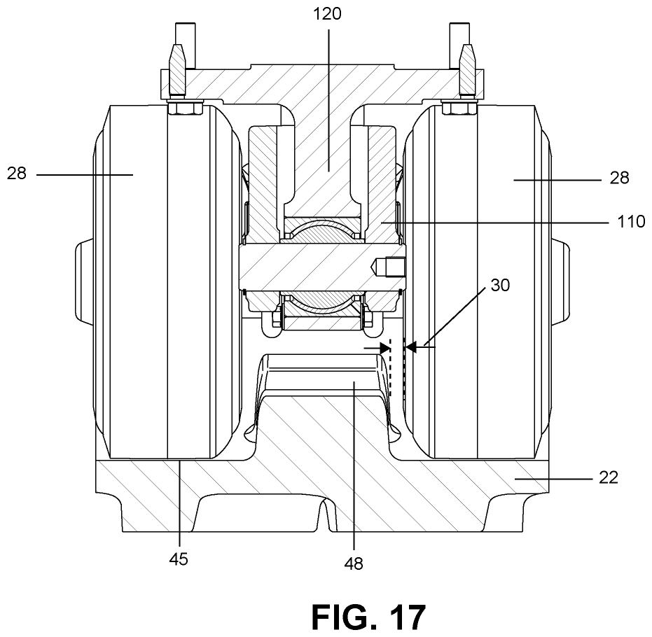

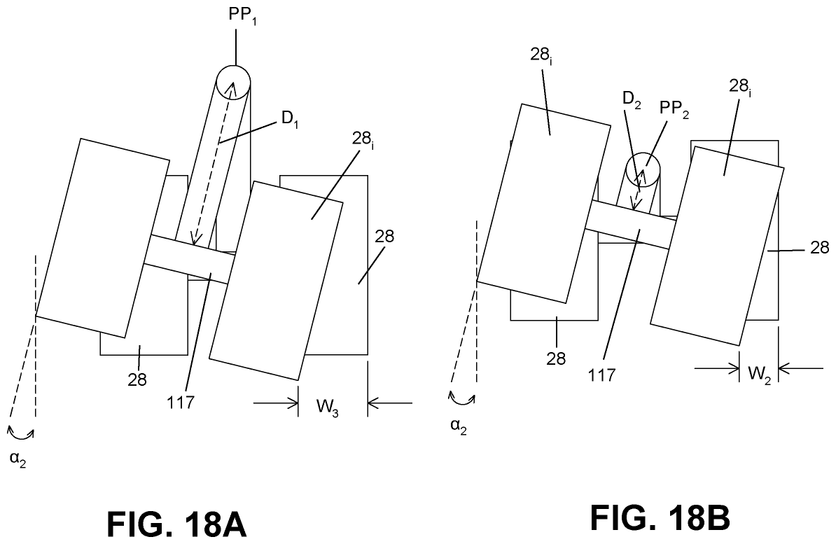

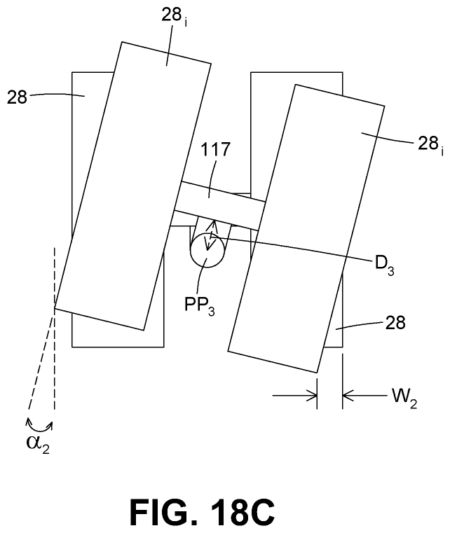

As best shown in FIGS. 17 to 18C, the mid-rollers 28 are positioned on either side of the drive or guide lug 48 that extends outwardly from the inner side 45 of the track 22. When the roller support beam 110 oscillates via the pivotal connection with the support assembly 120, the mid-rollers 28 move laterally in relation to the track 22, also known as “side swing”, and are displaced to position 28ᵢ. As shown in FIGS. 18A to 18C, as the distance between the pivot point for the mid-roller's 28 lateral oscillation and the mid-roller axle 117 increases, the width of the side swing increases, for the same angle α₂ of lateral oscillation or roll movement. FIG. 18A shows a representation of a lateral oscillation system with a relatively high pivot point PP₁ of a roller support beam, as illustrated by the distance D₁ between the pivot point PP₁ and the axle 117 of the mid-rollers 28, whereas FIGS. 18B and 18C show representations of lateral oscillation systems according to other embodiments, each with a low pivot point PP₂, PP₃ of a roller support beam, as illustrated by the short distances D₂, D₃ between the pivot point PP₂, PP₃ and the axle 117 of the mid-rollers 28, respectively. The lateral oscillation systems shown in FIGS. 18B and 18C differ only in the size of the mid-roller wheels (and thus differ in the distance between the ground or a bottom tangency of the mid-roller wheels and the mid-roller wheel axle).

As can be seen, the systems shown in FIGS. 18A to 18C each provide the same angle α₂ of lateral oscillation or roll movement (approximately 15° for illustrative purposes); however, the width W₃ of the side swing is significantly larger for the system shown in FIG. 18A that has a higher pivot point PP₁ than the width W₂ of the side swing with the systems shown in FIGS. 18B and 18C, which have a lower pivot point PP₂. As can be seen in FIGS. 18B and 18C, the size of the mid-rollers, and thus the distance between the ground or a bottom of the mid-roller wheels and the mid-roller wheel axle, affects the distance between the axis of rotation of the mid-rollers and the pivot axis of the roller support beam. In some embodiments, as shown in FIG. 18B, systems having a low pivot oscillation system, such as the lateral oscillation systems described herein, can have a longitudinal pivot axis that is less than 150 mm above the axis of rotation of the mid-roller wheels in a heightwise direction. Other systems can have a longitudinal pivot axis that is in line with (i.e., in the same plane as) the axis of rotation of the mid-roller wheels. In other embodiments, such as shown in FIG. 18C, the longitudinal pivot axis can be below the axis of rotation of the mid-roller wheels. In some embodiments, the longitudinal pivot axis is between 50 mm below the axis of rotation of the mid-roller wheels and 150 mm above the axis of rotation of the mid-roller wheels.

Providing a lower pivot point PP₂, PP₃ can also allow for lateral oscillation of the mid-rollers 28 while requiring a spacing between respective mid-rollers 28 that is substantially the same as or less than the spacing that would be required if there were no lateral oscillation. Notably, when a lateral oscillation pivot of mid-rollers is too high, the lateral oscillation can cause lateral movement of the mid-rollers relative to the front and rear idler wheels and/or the track 22, such that there may be an increased risk of contact between mid-rollers 28 and drive/guide lugs 48, which may prematurely damage the mid-rollers 28 and/or the track 22 and spacing between respective mid-rollers 28 may be significantly increased to mitigate this.

With specific reference to FIG. 17, the mid-rollers 28 are separated from the guide lugs 48 with a small clearance 30, such that under normal operating conditions, the outer edges of the guide lugs 48 do not, or rarely, come into contact with the inner surface of the mid-rollers 28. However, when the roller support beam 110 laterally oscillates to provide the mid-rollers 28 with rotation in the roll direction, the side swing of the mid-rollers 28 can cause an inner side of the mid-rollers 28 to contact the outer edges of the guide lugs 48, causing unnecessary friction and heat, which can lead to uneven erosion on the mid-rollers and guide lugs 48, as well as decrease the overall speed the track system can be operated at. By providing a lower pivot point PP₂, PP₃, the lateral oscillation system 100 is able to provide the same angle α₂ of lateral oscillation or roll movement while decreasing the negative effects caused by excessive side swing. Moreover, by providing a lower pivot point PP₂, PP₃, the lateral oscillation system 100 can provide a higher angle α₂ of lateral oscillation or roll movement before the side swing movement of the mid-rollers 28 cause the mid-rollers to come into contact with the guide lugs 48. In other words, the lateral oscillation system 100 may allow the mid-rollers 28 to be pivotable about the longitudinal pivot axis PA_{LO} by a greater angle α₂ of lateral oscillation or roll movement before the mid-rollers come into contact wit the guide lugs 48. For example, in some embodiments, each of the mid-rollers 28 may be pivotable about the longitudinal pivot axis PA_{LO} by at least +/−1° from a rest position of the mid-rollers 28, in some cases by at least +/−2° from the rest position of the mid-rollers 28, in some cases by at least +/−3° from the rest position of the mid-rollers, in some cases by at least +/−5° from the rest position of the mid-rollers, in some cases by at least +/−7° from the rest position of the mid-rollers 28, in some cases by at least +/−10° from the rest position of the mid-rollers 28, and in some cases by even more (e.g., at least +/−15°).

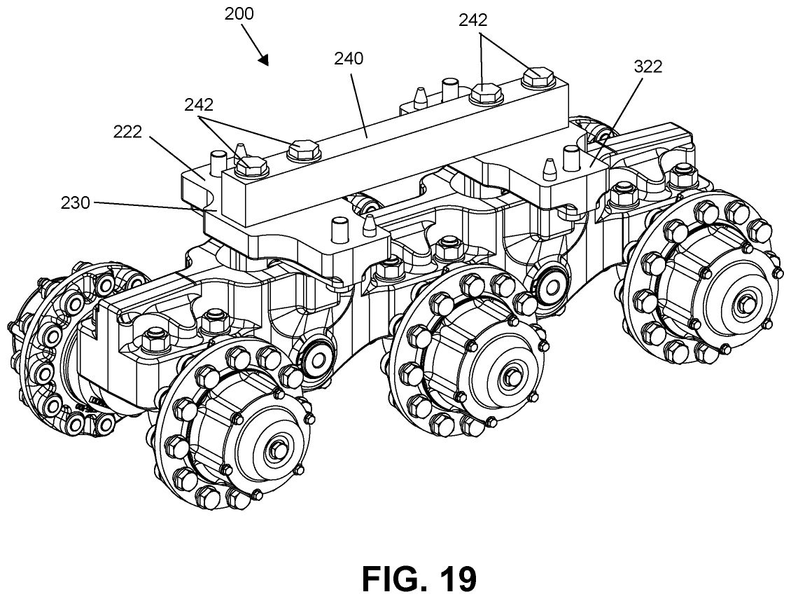

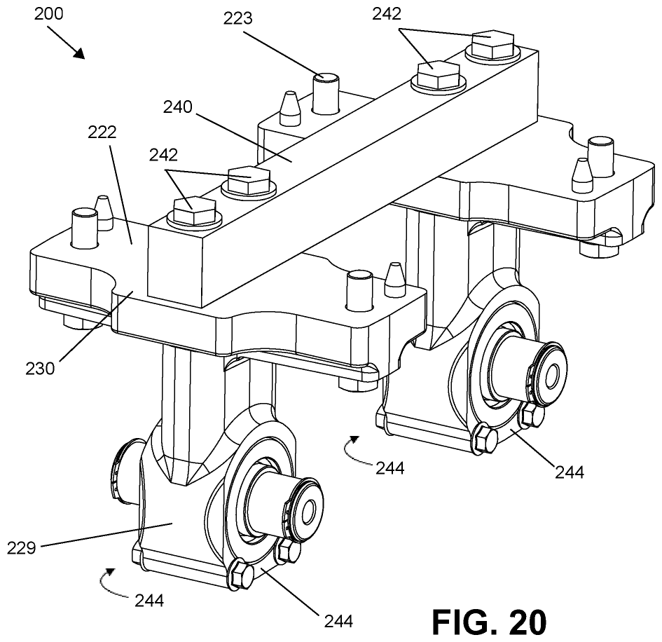

Referring now to FIGS. 19 and 20, in some embodiments, the lateral oscillation system 200 can include a tie bar 240 coupled to at least one of the connection flanges 222. In the exemplary embodiment, the tie bar 240 is coupled to the elevated surface 230 of the leading and trailing connection flanges 222 and extends therebetween. The tie bar 240 can be coupled to the connection flanges 222 by any known coupling means, such as welding or bolts. In the exemplary embodiment, the tie bar 240 is coupled to the connection flanges 222 with four mounting bolts or fasteners 242. The tie bar 240 can ease assembly and ensure that the fasteners connecting the connection flange 222 to the frame of the track system are not overloaded or over stressed by restricting movement of the connection flanges 222 relative to each other.

In some embodiments, the lateral oscillation system 200 can include one or more keeper plates 244 coupled on one or both sides of the bushing 224. The keeper plates 244 can prevent the bushing 224 from shifting outside of the bushing housing 229.

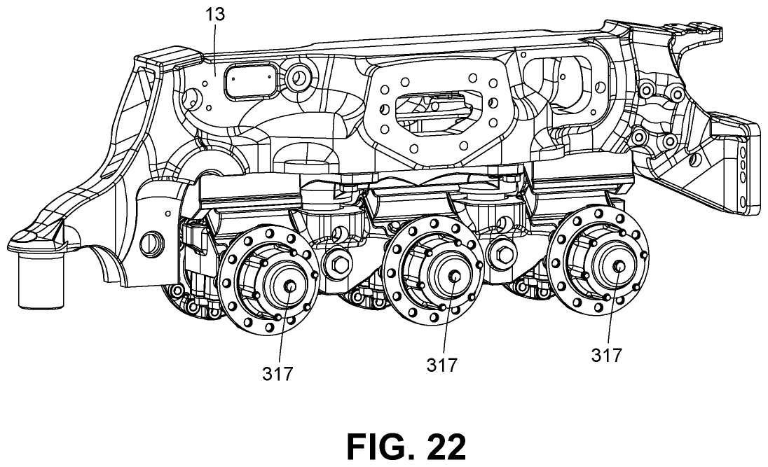

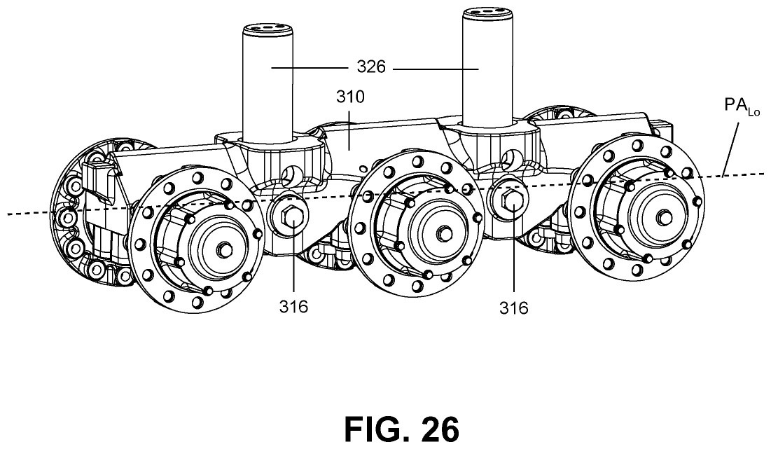

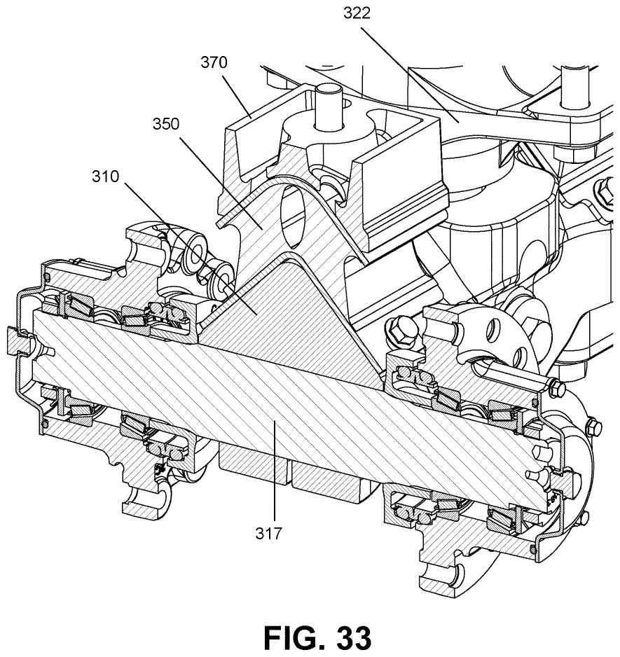

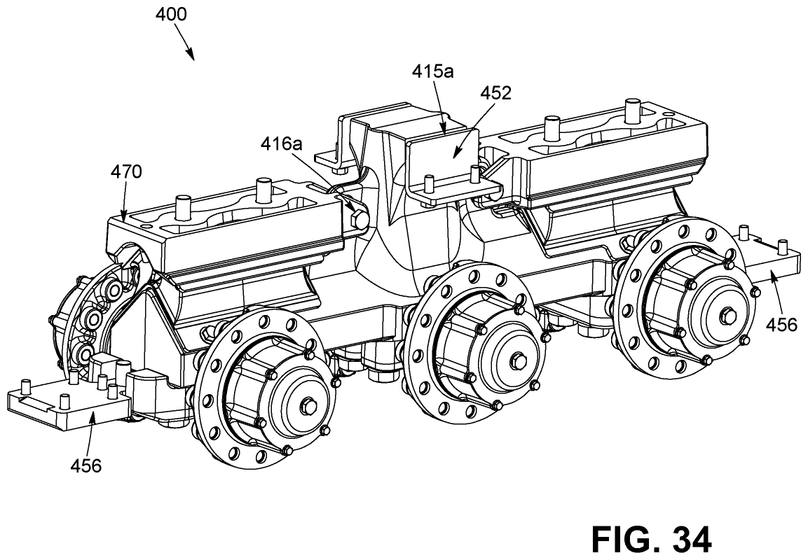

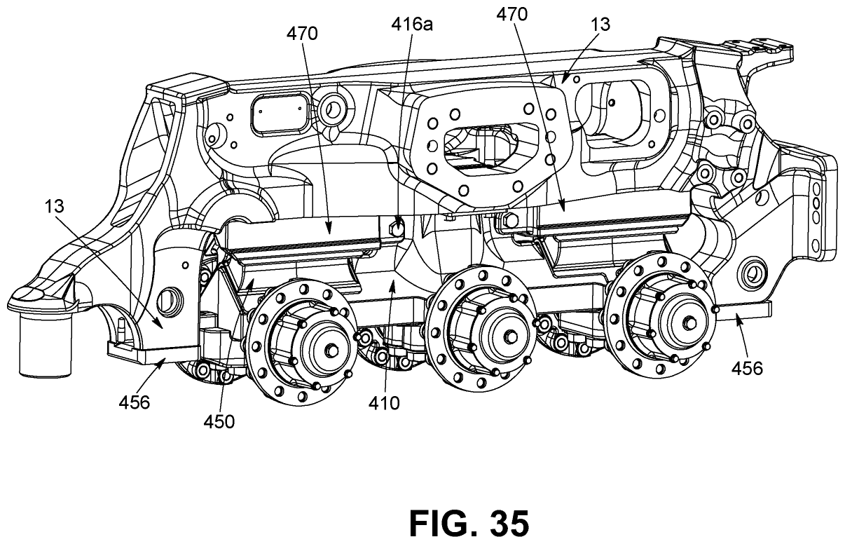

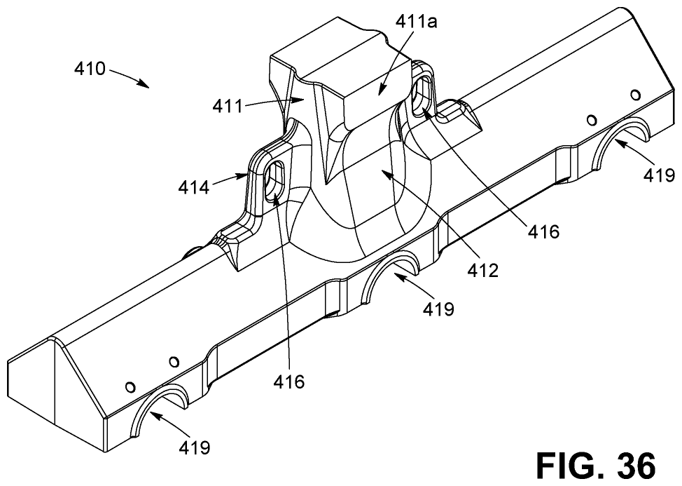

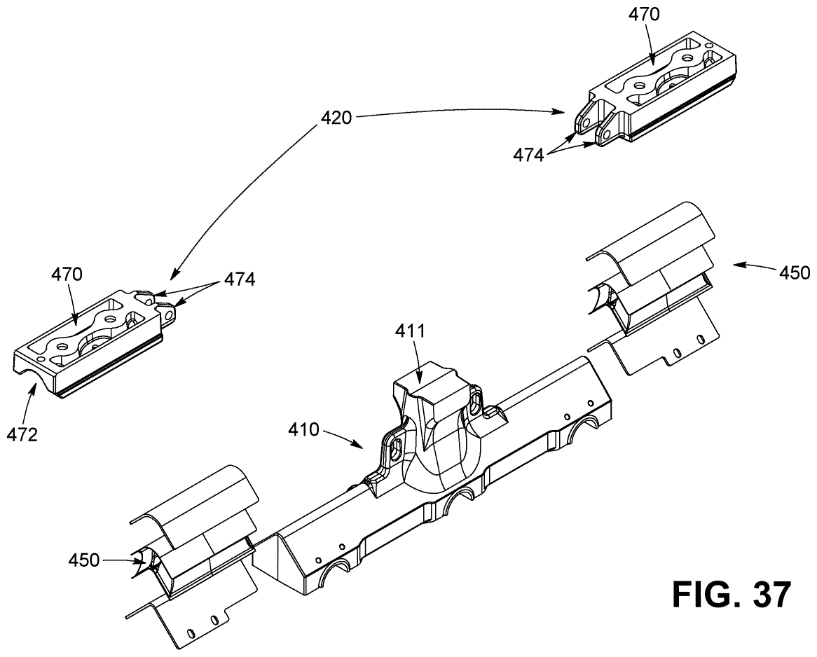

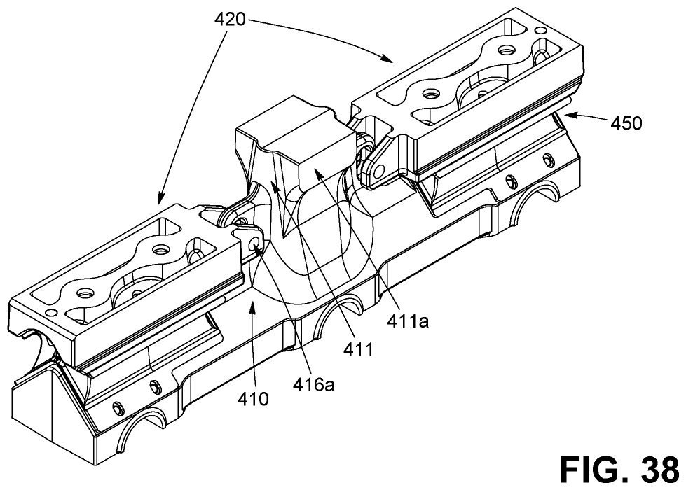

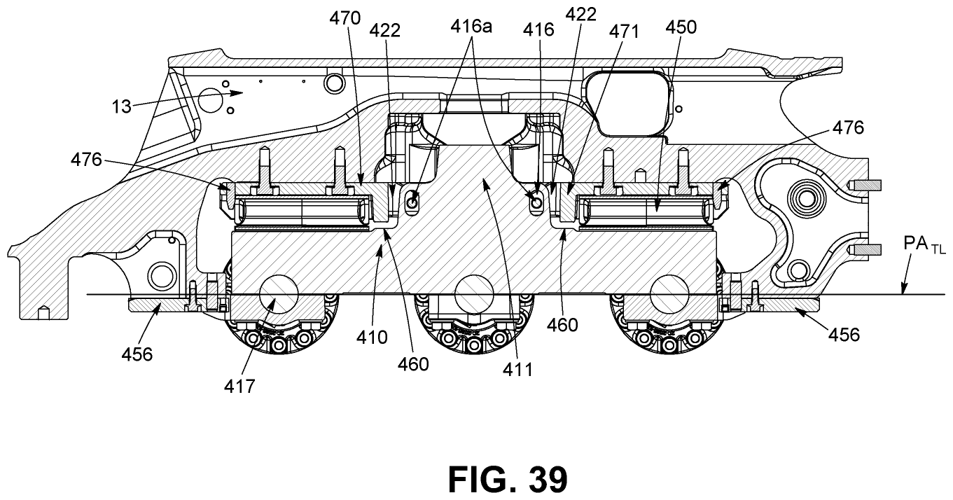

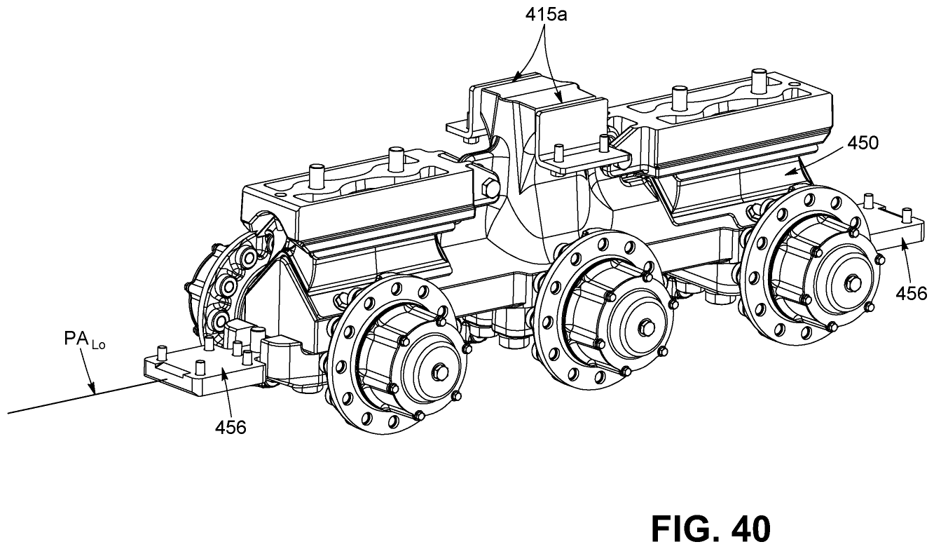

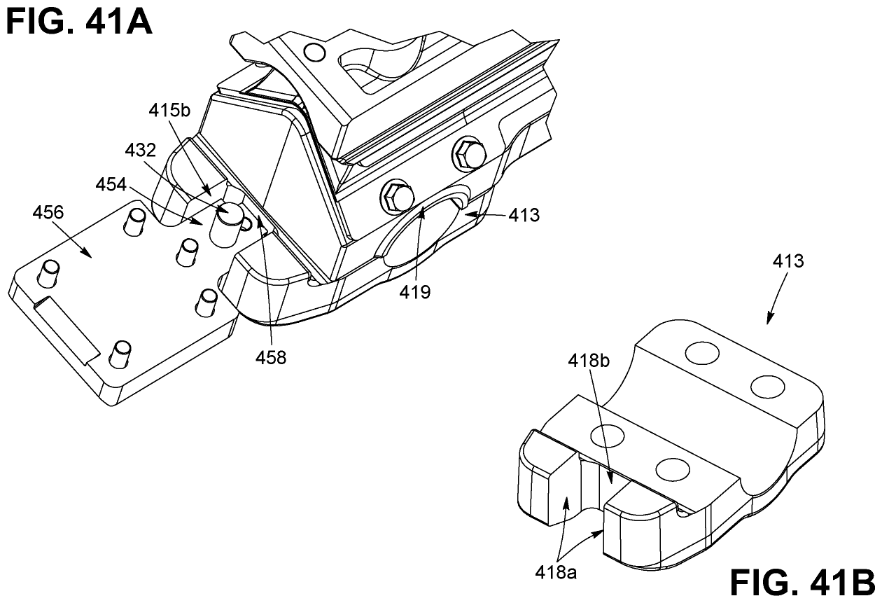

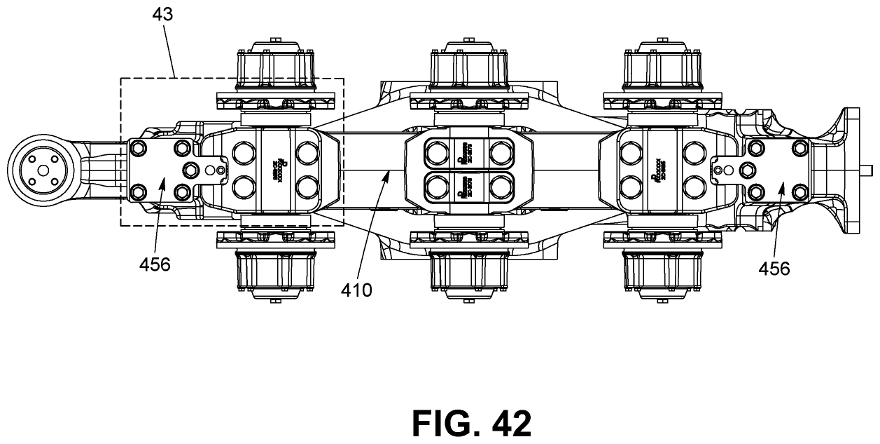

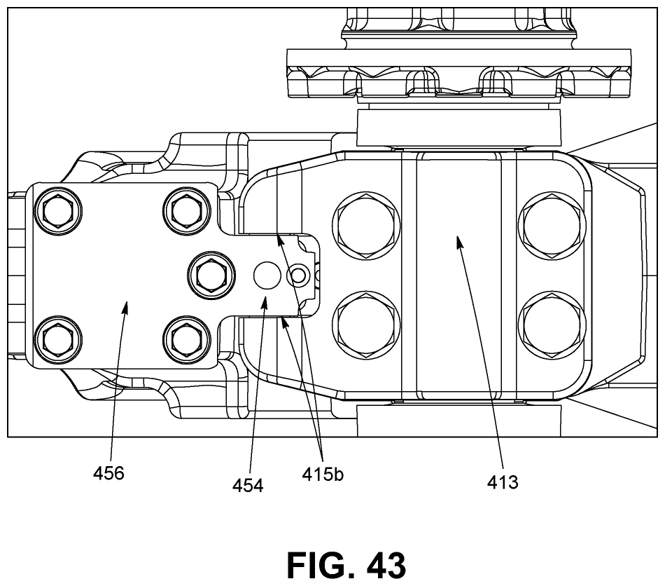

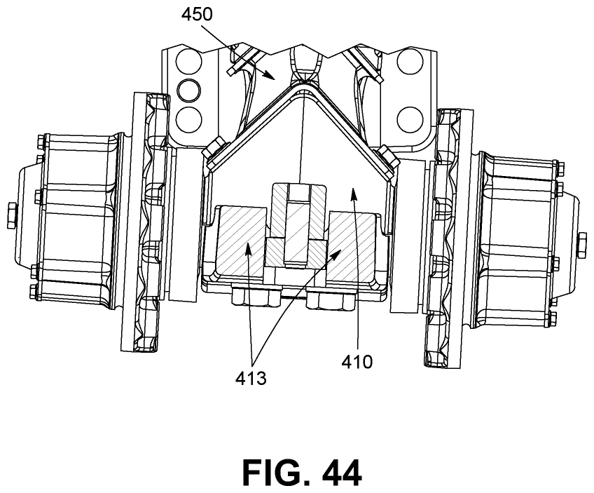

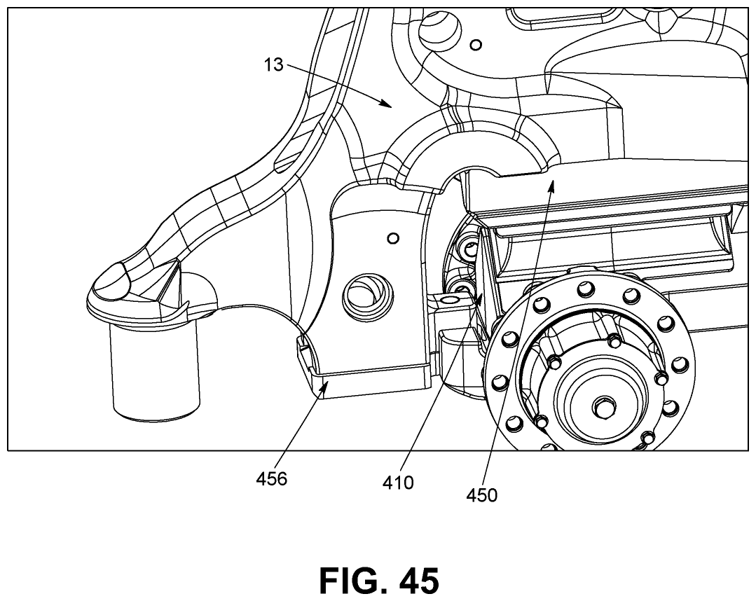

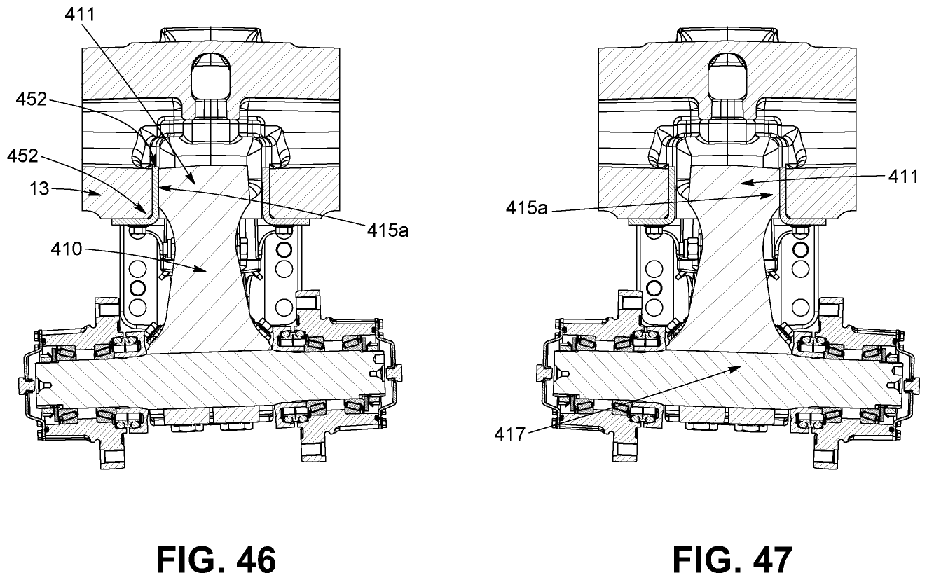

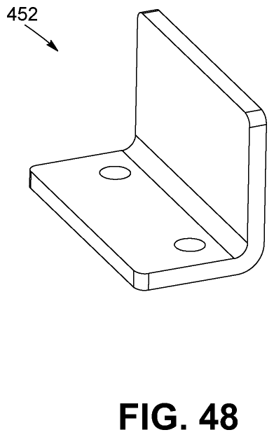

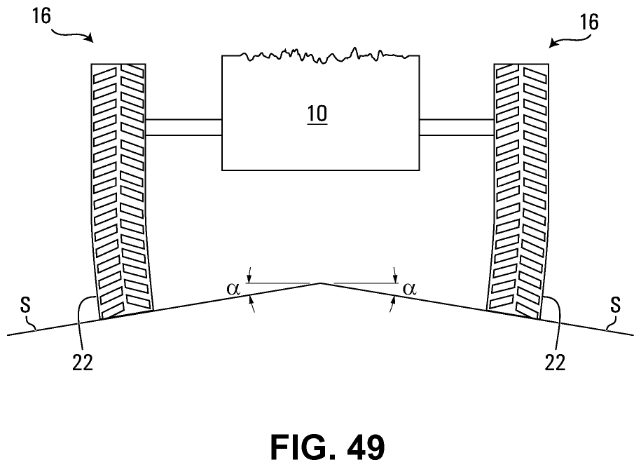

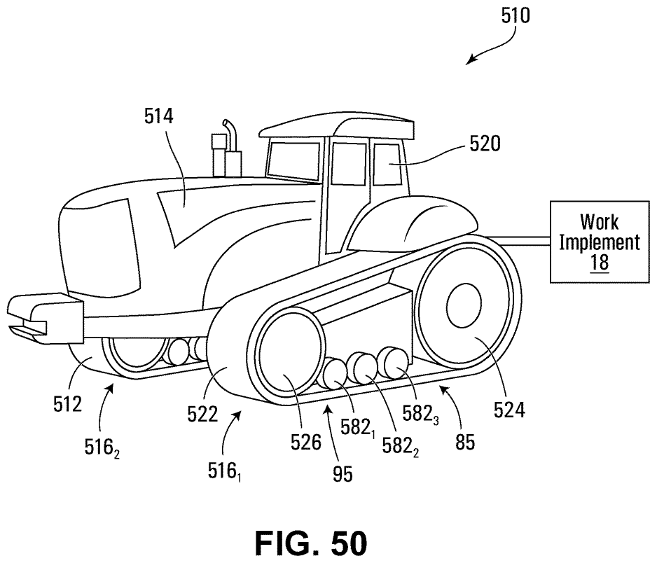

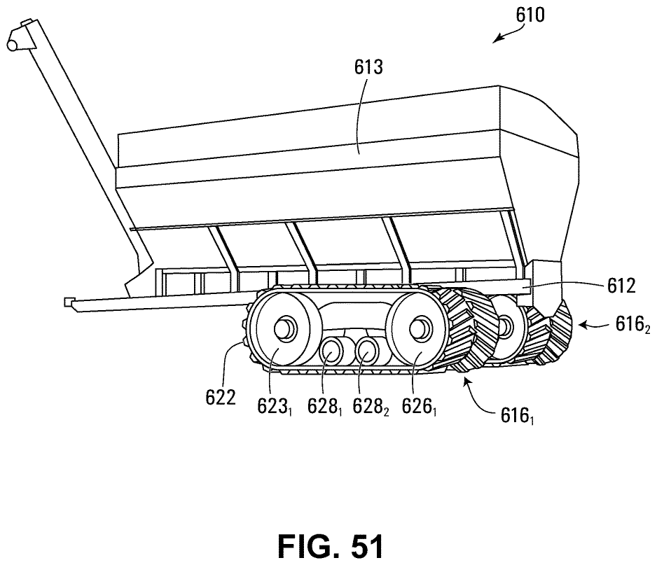

Referring now to FIGS. 21 to 33, a lateral oscillation system 300 according to another embodiment is shown. The lateral oscillation system 300 includes a roller support beam 310 and a support assembly 320. The roller support beam 310 is configured to be pivotally coupled to a frame 13 of a track system. In the exemplary embodiment, the support assemblies 320 are rigidly coupled to the frame 13 of the track system and pivotably coupled to the roller support beam 310.

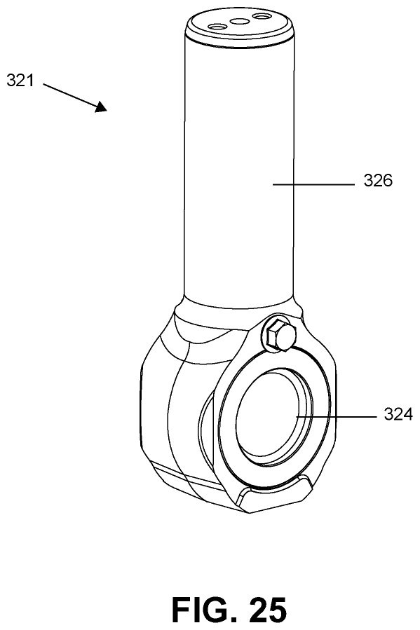

With specific reference to FIGS. 25, 30 and 31, the support assembly 320 includes a guide post assembly 321 and a connection flange 322. The support assembly 320 is rigidly connected to the frame 13 of the track system via the connection flange 322. The connection flange 322 is pivotably coupled to the guide post assembly 321 via a sleeve bearing or bushings 325 inside a housing 323 in the connection flange 322. The bushings 325 allows the guide post assembly 321, and thus the roller support beam 310, to move vertically or pivot relative to the connection flange 322 (and thus relative to the frame 13 of the track system) about a vertical pivot axis PAv that is perpendicular or transverse to the axis of rotation AR of the roller wheel axles 317. Rotation around the vertical pivot axis PAv (yaw rotation) can occur, for example, when the lateral oscillation system 300 only includes a single connection assembly 320. To reduce or eliminate the yaw rotation of the roller support beam 310, a yaw rotation stop can be included, such as surfaces on the frame 13 that prevent the roller support beam 310 from rotating around the vertical pivot axis PAv. Alternatively, or additionally, the lateral oscillation system 300 can include two or more support assemblies 320 to reduce or eliminate the yaw rotation. In the exemplary embodiment, having two connection assemblies 312 couplable to two guide post assemblies 321 reduces, or in some cases eliminates, the yaw rotation of the roller support beam 310.

The bushing 325 allows for vertical movement of the guide post assembly 321 (and thus the roller support beam 310) relative to the connection flange 322 (and thus relative to the frame 13). The lateral oscillation system 300 can further include a retainer plate 352 couplable to a top end of the guide post assemblies 321. The retainer plate 352 retains the guide post assembly 321, and thus the roller support beam 310, in a vertical relationship with connection flange 322, and thus of the frame 13, by preventing the guide post assembly 321 from extending below the top surface 322a of the connection flange 322. In the exemplary embodiment, a single retainer plate 352 is coupled to the top of both guide post assemblies 321. However, other embodiments are also contemplated, such as each guide post assembly 321 having a retainer plate 352 that engages with the connection flange 321 to prevent the vertical movement of the roller support beam 310 below the top surface 322a of the connection flange 322 and/or protrusions on the top end of the guide post assembly 321 to prevent the vertical movement of the roller support beam 310 below the top surface 322a of the connection flange 322.

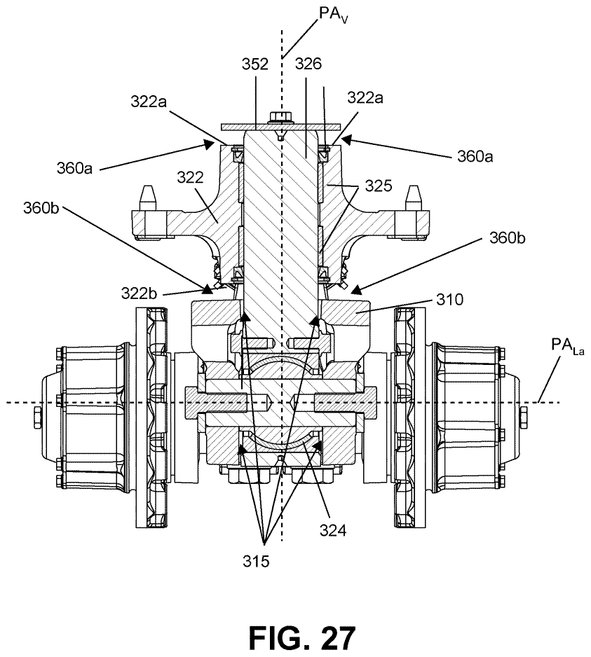

The vertical movement of the support assembly 321 is restrained by vertical suspension stops as discussed below. As best shown in FIG. 27, the lateral oscillation system 300 includes an upper clearance 360a between a top surface 322b of the connection flange 322 and a bottom surface of the retaining plate 352 and a lower clearance 360b defined by a bottom surface 322b of the connection flange 322 and a top surface of the roller support beam 310. The upper and lower clearances 360a, 360b adjacent to the top and bottom surfaces 322a, 322b of the connection flange 322 are provided to allow for the vertical movement of the roller support beam 310.

At the other (bottom) end thereof, the guide post assembly 321 is pivotally connected to the roller support beam 310 via the bushing 324. The pivotal coupling provided by the bushing 324 and/or the bushing 325 allows the roller support bar 310 to move or pivot relative to the guide post assembly 321 (and thus relative to the connection flange 322 and the frame 13 of the track system) about a longitudinal pivot axis PA_{LO} that is perpendicular or transverse to the axis of rotation AR of the roller wheel axles 317 (or traverse to a lateral pivot axis PA_{La}). In some embodiments, the pivotal coupling provided by the bushing 324 and/or the bushing 325 allows the roller support bar 310 to move or pivot relative to the guide post assembly 321 (and thus relative to the connection flange 322 and the frame 13 of the track system) about a lateral pivot axis PALa that is parallel to the axis of rotation AR of the roller wheel axles 317 (or traverse to the longitudinal pivot axis PA_{LO}), thus providing the roller support beam 310 with pitch rotation. As such, the two pivotal couplings between the frame 13 and the roller wheel axles 317 provide the roller wheels 28₁-28₃ with roll, yaw, and/or pitch rotation relative to the frame 13 of the track system.

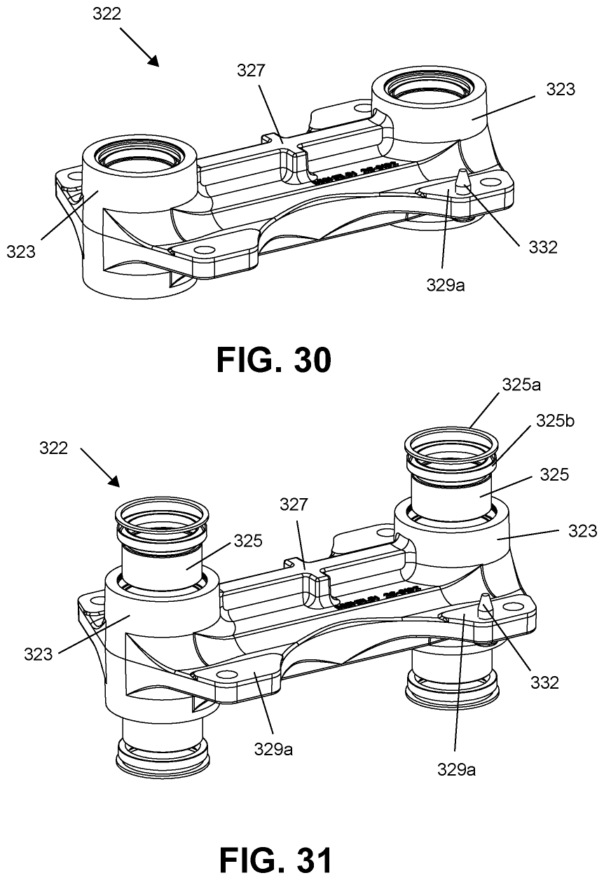

In the exemplary embodiment, as is best shown in FIGS. 30 and 31, the connection flange 322 includes flanges 329a extending on both lateral sides of the housings 324 with apertures configured to receive fasteners and a planar surface on the flanges 329a with apertures configured to receive fasteners. The planar surfaces on the flanges 329a are configured to abut against a bottom side of the frame 13 of the track system 16 to rigidly couple the frame 13 to the connection flange 322.

In some embodiments, the connection flange 322 can include alignment projections 332 that are configured to be received in an aperture in an underside of the frame 13 to align the apertures in the connection flange 322 with the apertures in the frame 13, such that a fastener can be threaded therethrough. In the exemplary embodiment, the flanges 329a on either lateral side of one housing 323 include an alignment projection 332. In the exemplary embodiment, the alignment protrusions 332 have tapered ends that facilitate an ease of entry into the apertures in the frame 13. It is contemplated that other alignment mechanisms can be used, including protrusions or elevated surfaces on an underside of the frame 13 of the track system that are configured to be received in apertures or a depression on the connection flange 322 (or vice versa).

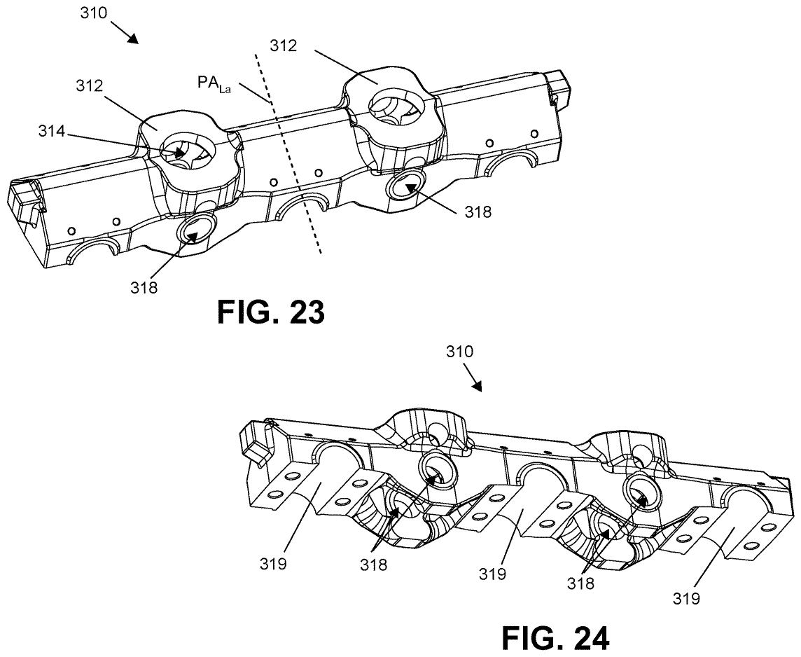

As best shown in FIGS. 23 and 24, in this embodiment, the roller support beam 310 comprises two connection assemblies 312 that each include a receiving port 314 configured to receive a portion of the support assembly 320 (in this embodiment, the guide post assembly 321) and an opening 318 configured to align with a bushing 324 on the support assembly 320 and receive a pin 316 therethrough. In this exemplary embodiment, the roller support beam 310 includes three roller wheel axle recesses 319 for receiving a roller wheel axle 317. In some embodiments, the roller support beam 310 includes the roller wheel axles 317. In the exemplary embodiment, the two connection assemblies 312 are dispersed between the three roller wheel axle recesses 319 (i.e., the connection assemblies 312 are positioned between adjacent roller wheel axles 317). It is contemplated that the roller support beam 310 can have any number of connection assemblies 312 dispersed between any number of roller wheel axles 317.

In some embodiments, the roller support beam 310 is configured to pivot about a lateral axis PA_{La} to impart a pitch movement on the roller support beam 310 relative to the frame 13 of the track system 16. In other words, the roller support beam 310 is pivotably about an axis that is parallel or substantially parallel to the axis of rotation AR of the roller wheel axles 317. Specifically, the bearing 325, which allows the guide post assembly 321, and thus the roller support beam 310, to move vertically relative to the connection flange 322, and thus the frame 13 of the track system. By having two support assemblies 320 with guide post assemblies 321 that can move vertically relative to the connection flange 322 independently of each other, the roller support beam 310 can pivot about the lateral axis PA_{La}.

With specific reference to FIG. 25, the guide post assembly 321 has a bushing 324 that is configured to be received in a receiving port 314 on the roller support beam 310 and a guide post 326. In the illustrated embodiment and unlike in lateral oscillation systems 100, 200, the connection flange 322 is separate from the guide post assembly 321 (and thus separate from the bushing 324 and guide post 326) and is configured to receive and coupled to one or more guide posts 326 in the housing 323 and, optionally, bushing 325. In the exemplary embodiment, the roller support beam 310 has two receiving ports 314, each configured to receive the bushing 324 of a guide post assembly 321 and the connection flange 322 is configured to receive and couple to the guide post 326 of two guide post assemblies 321.

The connection flange 322 can include one or more housing 323 with a bushing 325 that is configured to receive the guide post 326 on the guide post assembly 321. In the exemplary embodiment, the connection flange 322 includes two housing 323, each with a bushing 325, a retaining ring 325a, and a seal 325b, that are separated by the tie bar 327. Consideration to the potential yaw rotation of the roller support beam 310 should be given when determining the number of housings 323 on the connection flange 322. Specifically, having one housing with a bushing 325 configured to receiving a single guide post assembly 321 would result in significant yaw rotation of the roller support beam 310 relative to the frame 13, which could be mitigated or reduced by providing yaw rotation stops on the frame 13 that prevent or reduce the yaw rotation of the roller support beam 310. For example, the yaw rotation stops could include protrusions on both lateral sides of the frame 13 and at either longitudinal ends of the frame that are configured to engage with side or top surfaces of the roller support beam 310 and prevent the yaw rotation thereof.

The connection flange 322 is configured to rigidly connect to the frame 13, for example via fasteners through apertures. In the illustrated embodiment, the connection flange 322 is pivotally and slidably connected to the guide post assembly 321, which is pivotally connected to the roller support beam 310, thus providing additional degrees of freedom between the frame 13 and the roller support beam 310 than the lateral oscillation systems 100, 200.

In some embodiments, the lateral oscillation system 300 can include suspension pads 350 positioned between the roller support beam 310 and the support assembly 320 and/or between the support assembly 320 and the frame 13 of the track system 16. By providing suspension pads 350 between the roller support beam 310 and/or the support assembly 320 and the frame 13 of the track system 16, the vertical movement provided by the relationship between the bushing 325 in the connection flange 322 and the guide post 326 of the guide post assembly 321 is further dampened (in additional to the dampening provided by the bushing 324). In the exemplary embodiment, a suspension pad 350 is positioned between a bottom side of the tie rod 327 on the connection flange 322 of the support assembly 320 and a top side of the roller support beam 310 to further dampen the vertical movement of the roller support beam 310 relative to the frame 13 of the track system provided by the bushing 325. Additional suspension pads 350 are provided between a connection flange extension 370 coupled to the frame 13 and the roller support beam 310. In the exemplary embodiment, the connection flange extensions 370 are coupled to an underside of the frame 13 on a leading (front) and trailing (back) side of the housings 323 in the connection flange 322.

In some embodiments, the lateral oscillation system can include an oscillation stop 315 configured to limit or control the lateral oscillation provided by the oscillation system 300. In the exemplary embodiment, the oscillation stop 315 is defined by an inner surface of the receiving ports 314 and the outer side surface of the guide post 326, and thus a side surface of the support assembly (i.e., the inner surface of the receiving ports 314 restrains the movement of the guide post 326). Thus, lateral oscillation is limited to the width of the gap (i.e., the radial distance between the outer surface of the guide post 326 and the inner surface of the receiving port 314). Accordingly, the receiving port 314 of the roller beam support 310 is sized and shaped to receive the guide post 326 with a slight clearance. In other words, the size of the receiving port 314 should have a width that is wider than a width of the guide post 326, thereby providing a gap between the outer lateral walls of the guide post 326 and the lateral inner walls of the receiving port 314. In the exemplary embodiment, the oscillation stop 315 an engagement between the inner surface of the receiving port 314 above the bushing 324 and the outer side surface of the guide post 356 (i.e., when in the rested position, as shown in FIG. 27, there is an upper clearance between the receiving port 314 above the bushing 324 and the guide post 356) and an engagement between the inner surface of the receiving port 314 below the bushing 324 and the outer side surface of the guide post assembly 321 (and thus a side surface of the support assembly) around the bushing 324 (i.e., when in the rested position, as shown in FIG. 27, there is a lower clearance between the receiving port 314 below the bushing 324 and the guide post assembly 321). In the exemplary embodiment, the upper clearance is larger than the lower clearance.

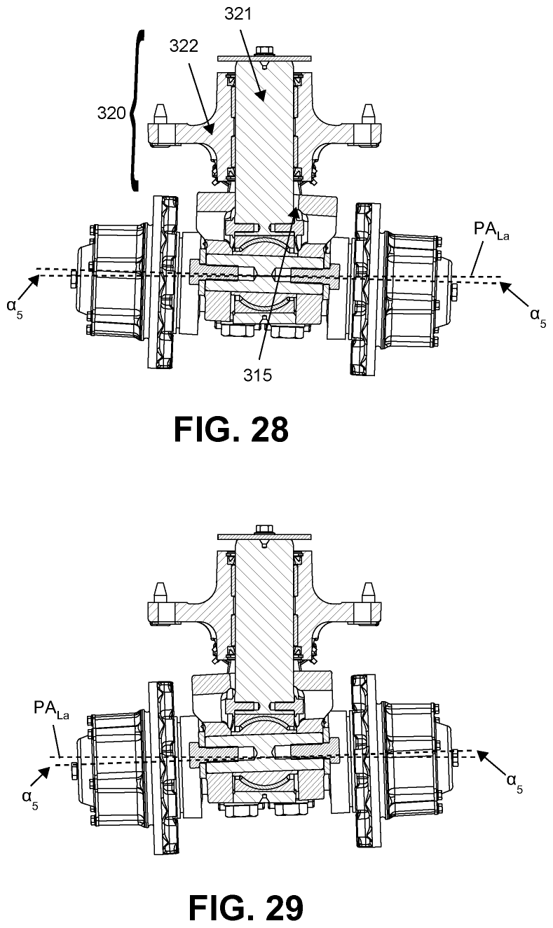

As is best shown in FIGS. 28 and 29, the lateral inner walls of the receiving port 314 can be configured such that they provide a predetermine range as of lateral motion, such as up to 1°, 2°, 3°, 4°, 5°, or as much as 10° in one direction (providing a range of motion of the roller support beam 310 relative to the frame 13 of between about +/−2° and about +/−20°). In the exemplary embodiment, the lateral inner walls of the receiving port 314 are tapered at an angle of about 2°, such that the guide post 326 is provided with a range as of lateral motion of 2° in both lateral directions (+/−2° of motion, which provides the roller support beam 310 with 4° of rotation relative to the frame 13).

In some embodiment, the lateral oscillation system 300 can include a vertical suspension stop configured to limit or control the vertical oscillation and/or the pitch movement provided by the oscillation system 300. The vertical suspension stop also contributes to preventing over compression of the suspension pads 350, for example, when the track system is subjected to a heavy load.

As best shown in FIG. 27, a vertical suspension stop can include the engagement between the top surface 322b of the connection flange 322 and the bottom surface of the retaining plate 352 (in which case, the upper clearance 360a would be zero) and/or the engagement between the bottom surface 322b of the connection flange 322 and the top surface of the roller support beam 310 (in which case, the lower clearance 360b would be zero). In such embodiments, the upper and lower clearances 360a, 360b adjacent to the top and bottom surfaces 322a, 322b of the connection flange 322 allow for the vertical movement providing by the bushing 325 and the top and bottom surfaces 322a, 322b of the connection flange 322 restricts the vertical movement of the guide post assembly 321, and thus the roller support beam 310, to the predetermined range. In other words, when the vertical movement of the guide post assembly 321 reaches the predetermined range, further vertical movement of the roller support beam 310 can be prevented by the top surface 322a of the connection flange 322 abutting or coming into contact with the retaining plate 352 and/or a bottom surface 322b of the connection flange 322 abutting or coming into contact with the roller support beam 310. Other configurations are also contemplated, such as the upper and lower clearances 360a, 360b being defined by upper and lower protrusions that are closer to the connection flange 322 than the retaining plate 352 and/or the roller support beam 310.

When determining the size of the lower clearance 360b defined by the bottom surface 322b of the connection flange 322 and the top surface of the roller support beam 310, consideration should be given to the degree of lateral oscillation that is provide by the clearances defining the lateral oscillation stop 315.

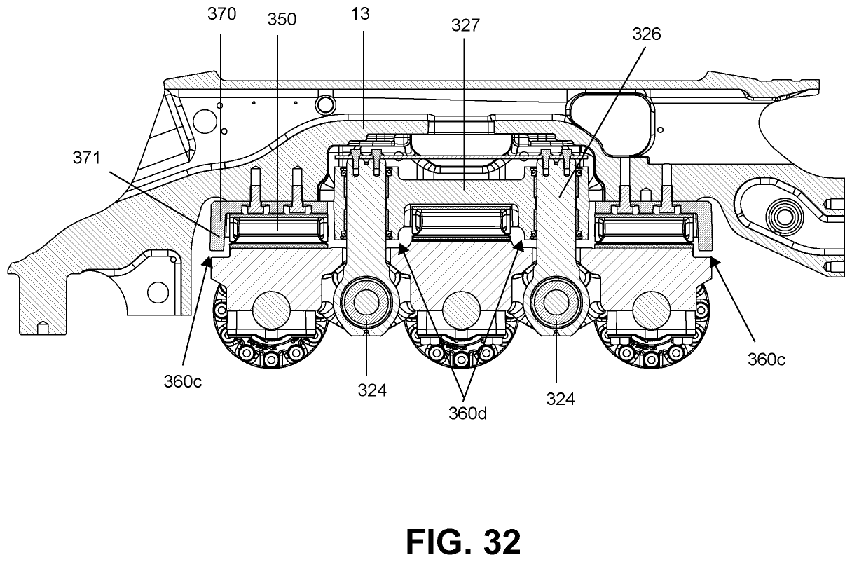

With specific reference to FIG. 32, in the exemplary embodiment, the vertical suspension stop can be provided via an engagement between the frame 13 or the support assembly 320 and the roller support beam 310. For example, in the exemplary embodiment, the connection flange extensions 370 coupled to the frame 13 can have a protrusion 371 with a bottom surface that is configured to interact with a top surface on one or both longitudinal ends of the roller support beam 310. In this embodiment, the protrusion 371 on the longitudinal ends of the connection flange extensions 370 interact with a surface on the top side of the longitudinal ends of the roller support beam 310. Accordingly, the vertical suspension stop is the engagement between the support assembly 320 (in this embodiment, the bottom surface of the connection flange extensions 370) and a top surface of the roller support beam 310 (i.e., the vertical movement is restrained by a protrusion on the connection flange extension 370). In other words, the clearance 360c between the connection flange extensions 370 and the roller support beam 310 provides space for the vertical movement of the roller support beam 310 relative to the frame 310, which is restrained to a predetermined amount by the protrusion 371.

Other configurations are also possible, such as a vertical suspension stop via the relationship between the connection flange 322 and the roller support beam 310. For example, the vertical suspension stop can include the engagement between a bottom surface of the tie bar 327 (and thus the support assembly 320) and a top surface of the roller support beam 310 between the connection assemblies 312. In other words, the clearance 360d between the tie bar 327 and the roller support beam 310 provides space for the vertical movement of the roller support beam 310 relative to the frame 310, which is restrained by a bottom surface of the support assembly 320 abutting a top surface of the roller support beam 310).

Unlike the lateral oscillation system 100, which is devoid of a suspension system that enables additional damping movement in the vertical direction and vertical damping is only provided by bushing 124, the lateral oscillation system 300 provides dampening of vertical impacts between the roller wheel axles 317 and the frame 13 via the bushing 324, the bushing 325, and, in some embodiments, the suspension pads 350.

When providing additional vertical damping with a suspension system, which in the exemplary embodiment comprises suspension pads 350, consideration should be given to the vertical relationship between a bottom tangency of the plurality of roller wheels 28₁-28₃ (which would be coupled to the roller wheel axles 317) and the bottom tangency of the front and rear idlers 23, 26, which can change depending on the vertical load of the track system 16 (i.e., as the vertical load increases, the distance between the bottom tangency of the roller wheels 28₁-28₃ and the bottom tangency of the front and rear idlers 23, 26 is decreased, and vice versa).

Referring now to FIGS. 34 to 47, a lateral oscillation system 400 according to another embodiment is shown. The lateral oscillation system 400 includes a roller support beam 410, support assembly 420, and optionally, suspension pads 450. In this embodiment, the lateral oscillation is provided by a pivotal relationship between the support assembly 420 and the roller support beam 410. In particular, the roller support beam 410 and the support assembly 420 coupled to a frame 13 of the track system are provided together in a spatial relationship (i.e., the roller support beam 410 is nested within the support assembly 420 and the frame 13), such that the roller support beam 410 pivots relative to the support assembly 420, and thus the frame 13, without having a pivotal coupling or link (such as the one provided by the bushing 324 in the lateral oscillation system 300).

The roller support beam 410 is configured to support the roller wheel axles 417 coupled to the roller support beam 410 in roller wheel axle recesses 419. In the exemplary embodiment, the suspension pads 450 are coupled to a top side of the roller support beam 410. The roller support beam 410 can include axle clamps 413 to secure the roller wheel axles 417 to the roller support beam 410. In the exemplary embodiment, the axle clamps 413 on the front and rear roller wheel axles 417 include a recess defined by side surfaces 418a and a longitudinally outward surface 418b. The recesses on the front and rear (leading and trailing) axle clamps 413 are configured to engage with the frame 13 (or a wear plate 456 coupled thereto) of the track system to restrain the longitudinal and lateral movement of a bottom side of the roller support beam 410 relative to the frame 13. However, it is also contemplated that a recess in the roller support beam 410 could be configured to engage with the frame 13 to restrain the longitudinal and lateral movement of the bottom side of the roller support beam 410.

As is best shown in FIG. 37, the support assembly 420 includes two connection flange extensions 470 that are rigidly coupled to the frame 13. The connection flange extensions 470 each include a suspension pad recess 472 that is configured to receive the suspensions pads 450 coupled to the top side of the roller support beam 410. In other words, the suspension pads 450, which are coupled to the roller support beam 410, are nested within the suspension pad recesses 472 of the connection flange extensions 470, and thus are nested within the support assembly 420.

In some embodiments, the roller support beam 410 can be disconnected or uncoupled from the support assembly 420, and thus from the frame 13, such that the roller support beam 410 remains in a position relative to the frame 13 via the nested relationship between the roller support beam 410 and support assembly 420 and the frame 13. In the exemplary embodiment, as shown best in FIG. 39, a protrusion 411 on the top side of the roller support beam 410 is nested within a recess in the frame 13 and the suspension pads 450 coupled to the top side of the roller support beam 410 on a leading and trailing side of the protrusion 411 are nested within the connection flange recesses 472 on the connection flange extensions 470. The longitudinal ends of the bottom side of the roller support beam 410 are nested within the longitudinal ends of the frame 13 and the suspension pads 450 coupled to top side of the roller support beam 410 are nested between aft/fore alignment projections 476. In the exemplary embodiment, the nesting of the protrusion 411 of the roller support beam 410 within the frame 13 retains the top side of the roller support beam 410 laterally within the frame 13. The nesting of the suspension pads 450 within the connection extension recess 272 and between the aft/fore alignment projections 476 also retains the top side of the roller support beam 410 laterally and longitudinally. The nesting of the longitudinal ends of the roller support beam within the frame 13 retains the bottom side of the roller support beam 410 laterally and longitudinally. As discussed below, a top clearance space between the protrusion 411 and the recess in the frame 13 and a bottom clearance space between side walls of a recess in the axle clamps 413 on the roller support beam 410 and the frame 13 are provided to allow the roller support beam 410 to laterally oscillate (i.e., the roller support beam 410 can be provided with roll rotation in the nested position in the frame 13).

In the exemplary embodiment, the roller support beam 410 is coupled to the support assembly 420 via a connection protrusion 412. The connection protrusion 412 includes flanges 414 extending in the leading (front) and trailing (back) sides of the connection protrusion 412 for coupling to the support assembly 420. The flanges 414 include oversized openings 416 that are configured to receive a pin 416a to couple the roller support beam 410 to the support assembly 420.

The connection flange extensions 470 each include protrusions 473 with aligned apertures 474 extending therethrough to receive a pin 416a. When assembled, the aligned apertures 424 on a given protrusion 423 align with a given one of the oversized openings 416 on the connection assembly 412 of the roller support beam 410. The oversized opening 416 is larger than the diameter of the pin 416a, which allows the pin 416a to move within the oversized opening 416, thus allowing movement of the roller support beam 410 (and thus the roller wheel axles 417) relative to the support assembly 420 (and thus relative to the frame 13 of the track system).

In the exemplary embodiment, the oversized openings 416 have a width and a height that is larger than the diameter of the pin 416a, which allows for longitudinal, lateral, and vertical movement of the support assembly 420 (and thus the frame 13 of the track system) relative the roller support beam 410 (and thus the roller wheel axles 417). In other words, the oversized openings 416 allow the forward and backward (which may also be referred to as fore/aft), side to side (or lateral), and vertical movement of the roller wheel axles 417 relative to the frame 13 of the track system. This movement is prevented in each direction by the longitudinal, lateral, and vertical movement stops except for the downward vertical movement of the roller support beam 410. In other words, during the normal operation of the track system, the pin 416a would only come into contact with the oversized openings 416 when the track system is not supported on an underside (such as, when the track system is lifted off the ground during maintenance). If the track system is not supported by the ground, the top side of the oversized openings 416 acts as a vertical movement stop to prevent the roller support beam 410 from being released from its nested position within the support assembly 420.

In some embodiments, the lateral oscillation system 400 can include suspension pads 450 to provide suspension to the roller support beam 410. The lateral oscillation system 400 can also include varies stops to restrain the longitudinal, lateral, and vertical movement of the roller support beam 410 within its nested position in the support assembly 420.

In some embodiments, the lateral oscillation system 400 can include an oscillation stop configured to restrain the lateral oscillation (or roll rotation) of the roller support beam 410 by a predetermined amount. In some embodiments, the oscillation stop can include an angled surface on a top surface of the connection assembly 412 that is configured to engage with a bottom or underside of the frame 13. In the exemplary embodiment, the lateral oscillation system includes a top oscillation stop 415a and a bottom oscillation stop 415b. The relationship between the top oscillation stop 415a and the bottom oscillation stop 415b provides a predetermined space for the roller support beam 410 to laterally oscillate within the nested position.

The top oscillation stop 415a is lateral surfaces of a recess on an underside of the frame 13 (i.e., internal surfaces of the frame 13) that are configured to engage with the lateral side surfaces 411a of the protrusion 411 extending upwardly from the connection assembly 412. However, other configurations are possible, such as one or more protrusions 411 extending upwardly from the roller support bar 410 that are separate from the connection protrusion 412. The frame 13 can include a wear plate 452 to prevent or reduce wear and erosion on the lateral side walls of the recess in the frame 13 that the protrusion 411 comes into contact with to stop the lateral oscillation (i.e., the top oscillation stop 415a) of the roller support beam 410. Accordingly, in this embodiment, the frame 13 (or, optionally, a wear plate 452 coupled to the frame 13) restrains the lateral oscillation of the roller support beam 410 at the top end thereof.

The bottom oscillation stop 415b is the side surfaces of a protrusion 454 of the frame 13 of the track system that are configured to engage with the side surfaces 418a of the recess on the front and back axle clamps 413. In the exemplary embodiment, the frame 13 includes a wear plate 456 with the protrusion 454 to prevent or reduce wear and erosion on the protrusion 454. In some embodiments, the wear plate 546 can include alignment projections 432 and/or fasteners configured to align and rigidly couple, respectively, the wear plate 256 to an underside of the frame 13 of the track system. Accordingly, in this embodiment, the frame 13 (or, optionally, a wear plate 456 coupled to the frame 13) restrains the lateral oscillation of the roller support beam 410 at the bottom end thereof.

As is understood by the skilled artisan, the lower clearance between the lateral side surfaces of the protrusion 454 and the lateral side surfaces 418a of the recess in the axle clamp 413 and the upper clearance between the lateral side surfaces 411a of the protrusion 411 and the opposing lateral surfaces of the recess in the frame 13 (in the exemplary embodiment, the surface of the wear plate 452) define the pivotal relationship between the roller support beam 410 and the support assembly 420 (and thus the frame 13). In other words, the lower and upper clearances define both the degree of lateral oscillation provided to the roller support beam 410 and where a theoretical longitudinal pivot axis PA_{TL} is located. In some embodiments, the upper clearance is between about 2 and about 8 times the lower clearance (or provided in an upper clearance to lower clearance ratio of between 2:1 and 8:1). In the exemplary embodiment, the upper clearance is about 5 mm and the lower clearance is about 1 mm (i.e., has an upper clearance to lower clearance ratio of 5:1), which provides a degree of lateral oscillation of about +/−2°from a rest position.

In other words, the top and bottom oscillation stops 415a, 415b are configured to restrain the lateral oscillation of the roller support beam 410 to +/−2°from a rest position; however, other predetermined amounts are also contemplated. As is best shown in FIG. 39, in the exemplary embodiment, the upper and lower clearances of the top and bottom oscillation stops 415a, 415b, respectively, allow the roller support beam 410 to pivot along a theoretical longitudinal pivot axis PALT that is vertically aligned (but traverse to) the axis of rotation of the roller wheel axles 417.

As will be understood by the skilled artisan, as the upper clearance increases relative to the lower clearance, the theoretical longitudinal pivot axis PA_{TL} lowers and thus is closer or traverses the rotational axis AR of the roller wheel axles. As discussed above, having a low pivot axis or pivot point reduces the side swing of the roller wheels.

In some embodiments, the lateral oscillation system 400 can include a longitudinal movement stop (which may also be referred to as a fore/aft travel stop). The longitudinal movement stop can also retain the roller support beam 410 longitudinally within its nested position in the support assembly 420 (i.e., prevents or reduces longitudinal or aft/fore movement).

In the exemplary embodiment, as best shown in FIGS. 41A and 41B, the longitudinal movement stop is the longitudinally inward surface 458 of the protrusion 454 of the wear plate 456 (i.e., the trailing surface on the front or leading protrusion 454 and the leading surface on the back or trailing protrusion 454) engaging with a longitudinal outward surface 418b of the recess 418 on the leading and trailing roller axle clamps 413. The longitudinal movement stop can be configured to restrain the longitudinal movement (forward and backward movement) or can be positioned so as to prevent any longitudinal movement. Accordingly, in this embodiment, the frame 13 (or, optionally, a wear plate 456 coupled to the frame 13) restrains the longitudinal movement of the roller support beam 410 at each end thereof and retains the roller support beam 410 in its nested position within the support assembly 420. The clearance between the longitudinally inward surface 458 of the protrusion 454 and the longitudinally outward surface 418b of the recess in the axle clamp 413 can be a predetermined amount depending on the track systems tolerance for longitudinal movement. In the exemplary embodiment, the clearance between the longitudinally inward surface 458 and the longitudinally outward surface 418 b is about 3 mm.

In some embodiments, the lateral oscillation system 400 can include partial longitudinal movement stops that are configured to prevent longitudinal movement up to a predetermined load. In the exemplary embodiment, the partial longitudinal movement stops include aft/fore alignment projections 476 extending downwardly from the suspension pad recesses 472 of the connection flange extensions 470. The aft/fore alignment projections 476 can be tapered to facilitate the alignment between the connection flange extensions 470 and the suspension pads 450 coupled to the roller support beam 410. In the exemplary embodiment, when assembled, the aft/fore alignment projections 476 have zero or nominal clearance with the longitudinal ends of the suspension pads 450, thus preventing any longitudinal movement of the roller support beam 410 relative to the support assembly 420 (and thus the frame 13). If the longitudinal (aft/fore) force is greater than a predetermined amount that the aft/fore alignment projections 476 can withstand, the longitudinal movement will be restrained by the longitudinally inward surface 458 of the protrusion 454 (i.e., by the frame 13).

With specific reference to FIG. 39, in some embodiments, the lateral oscillation system 400 can include a vertical suspension stop 460 configured to restrain the vertical movement of the roller support beam 410 by a predetermined amount. In the exemplary embodiment, the vertical suspension stop 460 is an underside surface of a protrusion 471 on the connection flange extensions 470 (and thus, of the support assembly 420), which is configured to engage with a topside of the roller support beam 410 and prevent over compression of the suspension pads 450. Accordingly, in this embodiment, the support assembly 420 restrains the vertical movement of the roller support beam 410 at the top end thereof. As discussed above, the pin 416a extending through the oversized openings 416 restrains the downward vertical movement of the roller support beam 410 when the roller support beam 410 is not supported on an underside, for example, by the ground.

Referring now to FIG. 49, lateral oscillation or roll movement capability may be useful when the agricultural vehicle 10 is roading, i.e., travelling on a road that typically has some degree of road crown. This capability of the track system 16 to better perform on road surface S may be particularly useful in situations such as this example in which the road's surface S has a cross slope (i.e., road crown) for leading water away from the road (i.e., to avoid water accumulation on the road). In this case, the cross slope of the road's surface S is such that the road has a crown, i.e., a highest point, at a center of the road in its widthwise direction and slopes downwardly on either side of the crown.

For instance, in some cases, an angle a defined between a horizontal axis and the road's surface S on either side of the crown may be between at least 1° and at least 10°, and in some cases even higher. The angle α may have any other value in other cases. In the exemplary embodiment, the track system 16 is configured to accommodate the road's surface S, including its crown in this example, so as to better distribute loading on its track 22 than a conventional track system and avoid or limit premature wear of the mid-rollers 28 and the track 22.

Although the agricultural vehicle 10 illustrated in FIG. 1 is an agricultural tractor comprising four track systems 16₁-16₄, different types of agricultural vehicles configured differently (e.g., having a different number of track systems) may implement improvements based on principles disclosed herein.

For instance, with additional reference to FIG. 50, an agricultural vehicle 510 may be provided comprising two track systems 516₁, 516₂ rather than four (i.e., a single track system on each side of the agricultural vehicle 510). The agricultural vehicle 510 also comprises a frame 512, a prime mover 514, and an operator cabin 520 and can be equipped with the work implement 18 to perform agricultural work. Each track system comprises a drive wheel 524 at a first longitudinal end portion of the track systems 5161, 5162, an idler wheel 526 at a second longitudinal end portion of the track systems 5161, 5162, opposite to the first longitudinal end portion, and a plurality of mid-rollers 528₁-528₃ intermediate the drive wheel 524 and the idler wheel 526. The track systems 5161, 5162, further comprise a track 522 disposed around the wheels 524, 526, and 5281-5283 and driven by the drive wheel 524. The track systems 516₁, 516₂ may implement the lateral oscillation systems 100, 200, 300, 400, such as the roller support beam 110, 210, 310, 410 and the support assembly 120, 220, 320, 420 as described above.

Furthermore, the work implement 18 that is drawn by the agricultural vehicle 10 or the agricultural vehicle 510 may implement the improvements disclosed herein. For instance, with additional reference to FIG. 51, the work implement 18 may comprise a trailed vehicle 610 comprising a frame 612, a body 613 (e.g., a container) and track systems 616₁, 616₂. In this example, the trailed vehicle 610 is a grain cart. In other examples, the trailed vehicle 610 may be a fertilizer cart, a sprayer, a planter or any other suitable type of trailed vehicle. Each of the track systems 616₁, 616₂ of the trailed vehicle 610 comprises front (i.e., leading) idler wheels 623₁ at a first longitudinal end portion of the track systems 616₁, 616₂, rear (i.e., trailing) idler wheels 626₁ at a second longitudinal end portion of the track systems 616₁, 616₂ opposite the first longitudinal end portion, and a plurality of mid-rollers 628₁-628₂ intermediate the front idler wheels 623₁ and the rear idler wheels 626₁. The track systems 616₁, 616₂ further comprise a track 622 disposed around the wheels 623₁, 626₁, 628₁, and 628₂. The track systems 616₁, 616₂ may implement the lateral oscillation system 100, 200, 300, 400, such as the roller support beam 110, 210, 310, 410 and the support assembly 120, 220, 320, 420 as described above. Additionally, or alternatively, the track 622 may be configured in a manner similar to the track 22 as described in section 2 above.

In this example, the trailed vehicle 610 is not motorized in that it does not comprise a prime mover for driving the track systems 6161, 6162. Rather, the trailed vehicle 610 is displaced by the agricultural vehicle 10 or the agricultural vehicle 510 to which the trailed vehicle 610 is attached. However, in some examples, the trailed vehicle 610 may be motorized. That is, the trailed vehicle 610 may comprise a prime mover for driving a drive wheel of each of the track systems 6161, 6162. For example, instead of comprising rear idler wheels 6261, the track system 6161 may comprise a drive wheel for driving the track 622.

In some examples of implementation, any feature of any embodiment described herein may be used in combination with any feature of any other embodiment described herein. Certain additional elements that may be needed for operation of some embodiments have not been described or illustrated as they are assumed to be within the purview of those of ordinary skill in the art. Moreover, certain embodiments may be free of, may lack and/or may function without any element that is not specifically disclosed herein.

Although various embodiments and examples have been presented, this was for purposes of description, but should not be limiting. Various modifications and enhancements will become apparent to those of ordinary skill in the art.

1. A track system for traction of a vehicle, the track system comprising:
an undercarriage comprising a track and a track-engaging assembly for driving and guiding the track around the track engaging-assembly, wherein the track engaging-assembly comprises:
a plurality of track-contacting wheels comprising a drive wheel for driving the track; a front idler wheel; a rear idler wheel; and a plurality of roller wheels;
a frame configured to couple to the vehicle and to the drive wheel, the front idler wheel, and the rear idler wheel; and
a lateral oscillation system comprising
a roller support beam comprising a plurality of roller wheel axles each configured to be coupled to the plurality of roller wheels; and
at least one support assembly rigidly coupled to the frame;
wherein the roller support beam and the at least one support assembly are in a pivotal relationship such that the roller support beam is pivotable about a longitudinal pivot axis transversal to an axis of rotation of the plurality of roller wheels by at least +/−1° from a rest position of the roller support beam; and
wherein at least a portion of the support assembly is received in the roller support beam or at least a portion of the roller support beam is nested within the support assembly and/or the frame.

2. The track system of claim 1, wherein the roller support beam further comprises at least one connection assembly positioned between adjacent ones of the plurality of roller wheel axles; and the at least one support assembly further comprises at least one pivotal link configured to pivotably couple to the roller support beam at a respective one of the at least one connection assembly to provide the pivotal relationship.

3. The track system of claim 2, wherein the at least one connection assembly comprises a receiving port and the at least one support assembly comprises a bushing, wherein the at least one pivotal link comprises the bushing coupled to the receiving port on the roller support beam via a pin.

4. The track system of claim 2, wherein the pivotal link is embedded in the roller support beam.

5. The track system of claim 1, wherein the support assembly comprises a connection flange rigidly coupled to the frame and a guide post assembly slidably coupled to the connection flange such that the guide post assembly provides the roller support beam with vertical movement.

6. The track system of claim 1, wherein the roller support beam is nested within the frame and/or the support assembly in a spatial relationship that provides the pivotal relationship.

7. The track system of claim 6, wherein a top side of the roller support beam is nested laterally within a recess in the frame with a top clearance between lateral side walls of the top side of the roller support beam and lateral side walls of the recess in the frame; and a bottom side of the roller support beam is nested laterally within the frame with a bottom clearance between lateral side walls of a recess in the roller support beam and lateral side walls of the frame;
wherein the top clearance and the bottom clearance comprise the spatial relationship that provides the pivotal relationship.

8. The track system of claim 7, wherein a ratio of the upper clearance to the lower clearance is between about 2:1 and about 8:1.

9. The track system according to claim 1, wherein the longitudinal pivot axis is between about 50 mm below and about 150 mm above the axis of rotation of the plurality of roller wheels in a heightwise direction.

10. The track system according to claim 1, wherein the lateral oscillation system further comprises an oscillation stop configured to restrain the lateral oscillation of the roller support beam relative to the frame, wherein the oscillation stop comprises a surface of the roller support beam configured to engage with a surface of the frame or a surface of the support assembly.

11. The track system of claim 10, wherein the surface of the roller support beam comprises a top surface of the roller support beam, an inner surface of the roller support beam, or a side surface of the roller support beam; the surface of the frame comprises an underside of the frame, an inner surface of the frame, or a side surface of the frame; and the surface of the support assembly comprises an underside of the support assembly, an inner surface of the support assembly, or a side surface of the support assembly.

12. The track system according to claim 1, wherein the lateral oscillation system further comprises suspension pads positioned between the roller support beam and the support assembly to provide vertical suspension of the roller support beam relative to the frame.

13. The track system of claim 12, wherein the lateral oscillation system further comprises a vertical suspension stop configured to restrain the vertical movement of the roller support beam relative to the frame to a predetermined amount.

14. The track system according to claim 1, wherein the lateral oscillation system further comprises a longitudinal movement stop configured to restrain longitudinal movement of the roller support beam relative to the frame to a predetermined amount.

15. The track system of claim 14, wherein the longitudinal movement stop comprises surfaces on the frame that are configured to engage with corresponding surfaces on the roller support beam.
